(19) United States
(12) Patent Application Publication
(10) Pub. No.: US 2005/0163164 A1
(43) Pub. Date: Jul. 28, 2005

(54) Display of video signals to subscribers

(75) Inventors: Jonathan Cramer, Savyon (IL); Gil Ingel, Rehovot (IL); Yosef Ben-Tsur, Petach Tikva (IL); Dror Nissim, Givataim (IL); Yossi Rubner, Shoham (IL); Joshua Piasetzky, Ramat Gan (IL); Hanita Piasetzky, Ramat Gan (IL); Yael Piasetzky, Ramat Gan (IL); Anat Piasetzky, Ramat Gan (IL)

Correspondence Address: BROWDY AND NEIMARK, P.L.L.C.;624 NINTH STREET, NW, SUITE 300, WASHINGTON, DC, 20001-5303, US

(73) Assignee: Affinient Ltd., Savyon (IL)

(21) Appl. No.: 11/019,940

(22) Filed: Dec. 23, 2004

(30) Foreign Application Priority Data
Dec. 23, 2003 (IL) 159530

(51) Int. Cl. H04L 12/28

(52) U.S. Cl. 370/486

(57) ABSTRACT

A method and apparatus are provided for enabling presentation of supplemented video signal in place of externally provided video signal at a subscriber's device. By an embodiment of this invention, based on certain attributes received from the TV programmer, certain parts of certain video signals are replaced by the subscriber's device with different content that has been pre-stored at that subscriber's device. In addition, such replacements may be reported to the TV programmer.

### FIELD OF THE INVENTION

The present invention relates to methods, devices and systems for manipulating broadcasts displayed for end-users. More particularly, to executing such manipulations in accordance with certain attributes.

### BACKGROUND OF THE INVENTION

Broadcast TV network programmers in the USA (e.g. ABC, CBS, Fox, NBC, etc.) typically assemble their networks at a national programming facility, on a national or regional basis, and transmit those networks' signals, typically in real time, to local TV stations with whom they are affiliated (“primary distribution”). Currently, these TV network programmers do not introduce any changes into their networks after such primary distribution.

The local TV Stations, by agreement with the TV network programmers with whom they are affiliated, insert video content of various types (entertainment, documentaries, news, promos, commercials, etc.) into those network signals at certain times and places, essentially in real time. They then transmit the so-changed network signal, typically in real time (“secondary distribution”). Each local TV station is associated with one broadcast TV network, and handles it and it alone in the abovementioned way. Currently, the local TV stations do not introduce any further changes into those networks after such secondary distribution.

The signals from local TV stations are received directly by viewers in some cases, but in most cases are first received by TV systems operators (such as cable TV system operators, satellite TV system operators, telecoms TV system operators, Internet TV system operators, etc.) who deliver them, typically together with a plurality of other TV networks in a multi-channel TV signal they create, to their subscribers for viewing and other “end-uses”.

TV systems operators are committed to deliver to their subscribers the content provided by the abovementioned parties without effecting any change to their viewable content.

In order to introduce required changes to the broadcast displayed at the end-user premises, quite a few solutions were proposed in the past.

U.S. Pat. No. 5,600,366 is an example of describes a method of replacing externally supplied video programming with local programming where the externally provided video programming includes embedded pre-roll cue and a roll cue, and a storage, where the local programming is stored, is activated in response to one of these tone cues, preparatory to initiating a playback.

USA 2002157093 is another example of such a solution, whereby at given local area, a program is broadcasted and stored, and in a predetermined time, a program which comprises the stored program and another program (e.g. advertisement) is repeatedly stored.

USA 2002184047 provides the detection of an avail that is suitable for at least two types of ads, querying an ad queue to determine which ad should be inserted in that avail, and delivering the ad to the subscriber.

US 2003061607 suggests a solution of delivering a combined program to the subscriber which is based on receiving entertainment content pre-recorded on a first medium and pre-recorded ads

However, some of the drawbacks associated with the prior art solutions are:

they are catered to handle only one TV Network (the network that is input into the solution) hence they are not capable of identifying the TV network that is currently handled, for accommodating a change of input from one TV Network to another, for handling different TV networks differently, etc.

they handle changes to the TV network for one party only; namely, for the Local TV Station (that is using the solutions). So they do not need or have capabilities for identifying for whom to perform changes at each change opportunity, for handling changes differently for different parties, etc.;

they support insertion by Local TV Stations, not by TV network programmers;

they do not enable each network programmer to define and control the changes performed in its part of the network;

typically, they handle only one type of change to the TV network; namely, inserting video into the network signal instead of video (if any) that was placed there by the network programmer. So they do not need or have capabilities for identifying the type of change possible at each change opportunity; for identifying the type of supplementary material to be used for changing the TV Network, or for selecting the one to suit the other;

typically, the supplementary material for insertion into the TV network is selected on the basis of time (predetermined time, or time indicated in a suitable alert signal “cue tone”), and the order of the of supplementary material, alone. Thus, when the time for a change arrives, the supplementary material is inserted so that it is shown at that time, or the supplementary material that is “at the top of the stack”. Typically, the prior art solutions do not offer capabilities for selecting the supplementary material to be inserted in accordance with additional criteria (such as: adjacent material in the TV network, adjacent supplementary material inserted, the expected audience, etc) and under the TV network's definition and control;

typically, these solutions are designed to operate on the original signal provided by the network programmer, before secondary distribution and before introduction to TV operators' systems. Therefore, they inherently rely on information found in the network programmers signal, which might be removed or changed in the processes of secondary distribution and handling by TV system operators; and

they are designed to operate in a TV station, and consume space and power, and generate heat and noise, accordingly.

Cable & satellite network programmers typically assemble their networks at a national programming facility, on a national or regional basis, and transmit those networks' signals, essentially in real time, to cable, satellite, telco, Internet and over-the-air system operators with whom they have suitable agreements (“primary distribution”). These network programmers do not introduce any changes into their networks after such primary distribution.

The system operators' package delivered to the operators' subscribers, essentially in real time, is comprised of a multi-channel TV signal received from a plurality of TV networks is formed at the operators' systems, referred to as “headend”. For a subscriber to access a certain network, a Set Top Box (“STB”) that can interwork with the cable system operators' signal, extracts the network's information from the multi-channel TV signal and reconstitutes it as a single viewable network signal. In this process, each network's signal may be subjected to various types of processing (such as analog/digital conversion, compression/decompression, rate conversion, partial regeneration, modulation/demodulation) which may change the content of the viewable or non-viewable part of the signal.

In some cases, prior to the packaging, some of the TV system operators (“TSO”s), by agreement with the some of the cable network programmers, insert, typically on a geographic/headend basis, video content of various types (primarily commercials; the TSOs typically do not have programming capabilities) into those network signals at certain times and places, essentially in real time. In these cases, they package the so-changed network signal into the multi-channel TV signal instead of the original signal.

Certain solutions have been proposed with the objective of enabling TSOs to insert video content into TV networks broadcasts at the Set Top Box (“STB”). However, these prior solutions are designed to enable the System Operator, not the Network Programmer, to plan, execute and monitor substitutions of content in the TV signal, and do not enable the network programmer to be involved in such substitutions or afford the network programmer control of such substitutions. Examples to such solutions are:
U.S. Pat. No. 6,463,585 discloses the use of additional channel(s) on the TSO distribution infrastructure to carry the alternate ads.
U.S. Pat. No. 6,002,393 describes the delivery of ads from a headend to the users by using a control device at the headend that sends commands to a control device display site to initiate the display of the ads.
USA 2002083445 discloses the use STBs that interwork with the TSO system.

In addition, certain solutions have been suggested with the objective of using PVRs to insert video content into TV networks broadcasts in the home. Examples of such solutions are found in U.S. Patent application US20030074661, disclosing a personal video recorder (PVR) for inserting a stored advertisement into a displayed broadcast stream, and US20030018968 which discloses insertion of data into video stream to enhance television applications.

These solutions are designed to enable the System Operator, not the Network Programmer, to plan, execute and monitor substitutions of content in the TV signal, and do not enable the network programmer to be involved in such substitutions or afford the network programmer control of such substitutions.

In accordance with the prior art solutions, TV network programmers were not able to change the content of their TV networks broadcasts after those broadcasts were transmitted from their central network-assembly facility in such a manner. As a result, TV network programmers today provide exactly the same content to myriads of TV sets on a national or, at best, regional basis.

In addition, local TV Stations were not able to change the content they insert into TV networks broadcasts after those broadcasts were transmitted from their stations in such a manner. As a result, local TV stations today provide exactly the same content to myriads of TV sets in their locality.

The disclosures of the references mentioned throughout the present specification are hereby incorporated by reference.

### SUMMARY OF THE INVENTION

It is therefore the object of the invention to provide a method and a system to overcome drawbacks of the prior art solutions. It is thus provided a method for enabling TV programmers to modify the contents (e.g.: language, soundtrack, subtitles, commercials, banners, logos, news flashes, tickers, programs, etc) of their TV content adjacent to or in TV sets that are receiving their content, essentially in real time, such that different modifications can be made at different locations, in a manner that is cost-effective and is viable under competitive considerations.

In addition, the present invention relates to enabling local TV stations to modify the contents that they have inserted into TV broadcasts adjacent to or in TV sets that are receiving those broadcasts, essentially in real time, such that different modifications can be made at different locations, in a manner that is cost-effective and is viable under competitive considerations.

The methods and devices provided by the present invention enable both TV network programmers and local TV stations to increase the relevance of their programming to viewers, and thus enhance the attractiveness of their networks to viewers and commensurately improve their networks' ratings, and enhance the impact of the advertising carried in their networks and commensurately augment its value.

Moreover, the present invention enables each TV network to accommodate more content of all types (entertainment, documentary, news, commercials, etc.) by simultaneously presenting different content to different TV sets when and as appropriate, and thus enable TV network programmers and local TV stations to use their networks with greater economic efficiency and derive greater value from them.

Further objects and features of the invention will become apparent to those skilled in the art from the following description and the accompanying drawings.

In accordance with a first embodiment of the invention there is provided an apparatus adapted to enable presentation at a subscriber premise of supplemented video signal in place of externally provided video signal, and comprising:
means for receiving at least one externally provided video signal;
means for receiving information related to attributes associated with said at least one externally provided video signal;
means for receiving information related to attributes associated with at least one supplementation opportunity related to said at least one externally provided video signal;
means for receiving at least one supplementary content signal and deriving therefrom information related to at least one supplementary content unit carried therein;
means for receiving information related to attributes associated with said at least one supplementary content unit;
storage means for storing at least part of the information related to at least one supplementary content unit and for storing at least part of the information related to the attributes associated with said at least one supplementary content unit;
means for extracting information related to at least one supplementary content unit out of said storage means, in accordance with information derived from at least two members of the group consisting of:
   a) said information related to attributes associated with at least one supplementation opportunity;
   b) said information related to attributes associated with said at least one supplementary content unit; and
   c) said information related to attributes associated with said at least one externally provided video signal;
means for incorporating said extracted information into said externally provided video signal to form a supplemented video signal; and
means for conveying said supplemented video signal.

According to another aspect of the present invention there is provided a system adapted to enable presentation of a plurality of video signals at a subscriber premise, comprising a central device and a plurality of TV displaying terminals, characterized in that a plurality of externally provided video signals are received at said central device and at least some of the externally provided video signals are distributed therefrom to the plurality of TV displaying terminals, as required.

By a preferred embodiment of the invention, there is provided a system adapted to enable presentation, at a subscriber premise, of supplemented video signals in place of externally provided video signals, and comprising:
a central device which comprises:
   means for receiving supplementary content signals and deriving therefrom information related to supplementary content units carried therein;
   means for receiving information related to attributes associated with said supplementary content units;
   storage means for storing at least part of the information related to said supplementary content units and for storing at least part of the information related to the attributes associated with said supplementary content units;
   means for selecting supplementary content units for incorporation into at least one video signal to be displayed at at least one device connected to or hosting a supplementation terminal associated with said central device, extracting information related to said supplementary content units out of said storage means, and deciding on their incorporation within the externally provided video signals;
   means for forwarding said supplementary content units thus selected towards at least one supplementation terminal;
at least one supplementation terminal which comprises:
   means for receiving from said central device supplementary content selected for incorporation into an external video signal at said at least one supplementation terminal;
   means for incorporating supplementary content thus received into said external video signal;
   means for forwarding externally provided video signals in which supplementary content unit has been incorporated to enable the display of the supplemented externally provided video signals.

In accordance with a preferred embodiment, the central device further comprises means for receiving and extracting information related to attributes associated with an external video signal, and more preferably, the central device also comprises means for receiving a plurality of externally provided video signals.

According to another preferred embodiment of the invention, the central device further comprises means for incorporating the extracted information into the externally provided video signals, to form supplemented video signals.

In an alternative preferred embodiment of the present invention, the at least one supplementation terminal further comprises means for receiving at least one externally provided video signals, and preferably, also means for receiving and extracting information related to attributes associated with an external video signal. Still preferably, the at least one supplementation terminal further comprises means for conveying to said central device at least part of the received information that relates to attributes associated with the external video signal.

In accordance with yet another preferred embodiment, the at least one supplementation terminal further comprises means for receiving information related to attributes associated with at least one supplementation opportunity related to at least one externally provided video signal, and preferably, the at least one supplementation terminal further comprises means for conveying to the central device at least part of the received information related to attributes associated with at least one supplementation opportunity that relates to at least one externally provided video signal.

According to still another preferred embodiment of the invention, the subscriber device (or the at least one supplementation terminal, as the case may be) comprises a part of a host device, where said host device is preferably adapted to display the supplemented video signal. By a preferred embodiment, such a host device is adapted to store the external video signal, and in addition or in the alternative, the host device is adapted to retrieve the external video signal from a plurality of video signals.

By yet another aspect of the present invention there is provided a system adapted to enable presentation, at a plurality of subscriber premises, of supplemented video signal in place of externally provided video signals, and comprising:

at least one processing center;

means operative to convey supplementation data to said processing center;

means operative to convey programmer data to said processing center;

means operative to convey subscriber data to said processing center;

means operative to process the data conveyed to said processing center;

means operative to convey processed information from said processing center to a plurality of subscriber devices of the present invention.

Preferably, the processing center is operative to store and process one or more of the group consisting of: supplementation data, programmer data, subscriber data and any combination thereof and to create appropriate derivatives thereof.

By another preferred embodiment of this aspect of the invention, the system comprises a plurality of transport means adapted to receive subscribers' data and activity data from said plurality of subscriber devices and convey signals corresponding to the data received to said process center.

By yet another aspect of the present invention, there is provided a method for enabling presentation at a subscriber premise of supplemented video signal in place of externally provided video signal, which comprises:
receiving at least one externally provided video signal;
receiving information related to attributes associated with said at least one externally provided video signal;
receiving information related to attributes associated with at least one supplementation opportunity related to said at least one externally provided video signal;
receiving at least one supplementary content signal and deriving therefrom information related to at least one supplementary content unit carried therein;
receiving information related to attributes associated with said at least one supplementary content unit;
storing at least part of the information related to at least one supplementary content unit;
storing at least part of the information related to the attributes associated with said at least one supplementary content unit;

extracting information related to at least one supplementary content unit, in accordance with information derived from at least two members of the group consisting of:
a) said information related to attributes associated with at least one supplementation opportunity;
b) said information related to attributes associated with said at least one supplementary content unit; and
c) said information related to attributes associated with said at least one externally provided video signal; and
incorporating said extracted information into said externally provided video signal to form a supplemented video signal.

According to still another aspect of the invention there is provided a method for enabling presentation at a subscriber premise of supplemented video signal in place of externally provided video signal, which comprises associating attributes with one or more supplementary content signals comprising information that enables identifying at least one member of the group associated with said at least one supplementary content signal and consisting of: a party(ies), type, duration, context requirements, audience requirements, timing requirements, repetition requirements and relationship requirements.

By yet another embodiment of the invention there is provided a method for enabling presentation at a subscriber premise of supplemented video signal in place of externally provided video signal, which comprises associating attributes with one or more supplementation opportunities comprising information that enables identifying at least one member of the group associated with said at least one supplementation opportunity and consisting of: party(ies), identifier(s), type, start, end and relationship requirements.

According to still another embodiment of the invention, there is provided a method for enabling presentation at a subscriber premise of supplemented video signal in place of externally provided video signal, which comprises associating attributes with one or more external video signals comprising information that enables identifying at least one member of the group associated with said at least one external video signal and consisting of: part(ies), identifier(s), category(ies), content, content-category(ies), content-rating(s) and group relationships.

In accordance with another embodiment of the invention there is provided a method for enabling, at a subscriber premise, incorporation of a supplementation content unit within an externally provided video signal, in case that each of the following criterion apply: p0 (i) if the value of EV_A_i is within a pre-defined set of EV_A_i's and/or the EV_A_gr value is within a pre-defined set of EV_A_gr's;
(ii) if EV_A_pi meets pre-defined terms of inclusion and exclusion;
(iii) if EV_A_pc meets pre-defined terms of inclusion and exclusion;
(iv) if EV_A_pr meets pre-defined terms of inclusion and exclusion; and
(v) if SO_A_soi complies with the pre-defined SC's timing requirements.

Preferably, the method further comprises the condition that:
(vi) if the relevant subscriber data matches certain attributes of the SC.

### BRIEF DESCRIPTION OF THE DRAWINGS

The present invention will be understood and appreciated more fully from the following detailed description, taken in conjunction with the drawings in which:

FIG. 1—is a block diagram illustrating a system operative in accordance with the present invention.

FIG. 2—presents a schematic detailed illustration of a device construed in accordance with the present invention adapted to operate at the subscriber premises;

FIG. 3—presents a schematic illustration of another embodiment of a device construed in accordance with the present invention adapted to operate at the subscriber premises;

FIG. 4—presents a flow chart diagram of a method of implementing the present invention at the subscriber's premises.

### DEFINITIONS & GLOSSARY

AD—Activity Data—Any and all data derived from the activities of a subscriber detected by the subscriber device and/or via a subscriber device, for example:
   Data about supplementation activity (e.g.: what was incorporated when, into which EV_A_i, partially or fully, with what results, etc)
   EV_A_i changes detected
   Subscriber's activities e.g.: responses to SC or EV that encourage response; log-on; etc.
   “VPRD On” checks and/or detection
   “subscriber present” checks and/or detection
   subscriber device power-up, power-down, reboot
   subscriber device configuration and reconfiguration
   subscriber device maintenance activities
BC—subscriber device—A device located in or adjacent to a VPRD for the purpose of providing service to that VPRD in accordance with the present invention;
BC_A—Attributes associated with a subscriber device.
CSO—Cable TV Operator
EV—External Video—Video that comes from outside the system of the present invention, and exists independently of the system of the present invention, and is destined for a VPRD
EV_A—EV Attributes—Information about at least one EV that may be used, among others, in decision making about incorporating SC into said EVs.
EV_A_S—EV_S Attribute Signal—A signal from which, with suitable interpretation, at least one EV_A can be derived;
EV_S—External Video Signal—The signal that conveys the EV;
LID—Local Input Device—A device that enables a user to input data to the BC. E.g.: a user's handheld electronic device for remote control;
LID_S—LID Signal—The signal or signals received by a BC from a LID;
NS—Processing Center;
PC—Programmer Customer—A TV Network Programmer who implements or uses the present invention;
PC_A—Programmer Customer Attributes;
PC_A_S—Programmer Customer Attributes Signal;
PC_C—Programmer Customer Commands relating to incorporation, including without limitation commands per VPRD and per subset of Subscriber Data.
PD—Programmer Data—Any or all of the data included in the following group: PC_A, PC_G_A, PC_C and/or parts thereof;
PD_S—PD Signal—A signal or signals that carry PD;
PC_G—Group of PCs, where each of its members share a common characteristic with the others; e.g.: who co-operate in some manner such as selling and/or displaying certain supplementary content; who are jointly owned in whole or in part;
PC_G_A—attributes of a PC_G;
RD—Subscriber Data—Any or all of the data associated with or related to a subscriber and/or a subscriber device including RS_A and BC_A and/or parts thereof;
RD_S—RD Signal—A signal or signals that carry RD;
RS—Subscriber, a person who is registered to receive service in accordance with the present invention.
RS_A—Subscriber's Attributes.
RS_A_S—Subscriber's Attributes Signal;
SC—Supplementary Content data in any applicable form, including, without limitation, video, audio, graphics, data, intended for incorporation into an EV_S.
SC_A—Supplementary Content Attributes
SC_A_S—Supplementary Content Attributes Signal—A signal from which, with suitable interpretation, at least one SC_A can be derived.
SC_G—Supplementary Content Group—A group of SC that have certain common attributes; e.g.: The group members are complementary (e.g.: different ads—of same or different types—for a product that complement each other and should be shown in a certain relation to each other).
SC_S—Supplementary Content Signal—A signal from which, with suitable interpretation, at least one item of SC can be derived.
SD—Supplementation Data—Any or all of the group SC, SC_A, SO_A, EV_A and/or parts thereof;
SEV_S—Supplemented External Video Signal—the EV_S after conversion if applicable and incorporation of SC;
SO—Supplementation Opportunity—An opportunity to supplement an EV_S by incorporating at least one item of SC into it.
SO_A—Supplementation Opportunity Attributes—Information about a SO, that may be used among other ways in decision making about incorporating SC into EV_S.
SO_A_S—Supplementation Opportunity Attributes Signal—A signal from which, with suitable interpretation, at least one SO_A can be derived;
SO_G—Supplementation Opportunity Group—A group of SOs that have certain linking attributes; e.g.:
   The timing of the group members forms a continuum e.g. a pod of SOs
   The group members are intended for complementary SC;
SO_G_A—Supplementation Opportunity Group attributes
SSO—Satellite TV Operator;
TV Network—Includes, without limitation, broadcast networks (e.g.: ABC, CBS, Fox, NBC), cable networks (ESPN, MTV, etc), satellite networks (e.g.: Starz!) and viewer-controlled TV service such as Pay Per View and Video On Demand;
TV Network Programmer—A party who assembles, in whole or in part, one or more TV Network or part thereof or on-demand TV content. In the case of broadcast networks, this includes, without limitation, both the national broadcaster and local TV stations (that may change content in broadcast networks).
TV Operator, TV System Operator (TSO)—A party who facilitates the delivery of, and/or delivers, one or more TV signals to consumers and other recipients. E.g.: a cable TV operator, satellite TV operator, over the air TV Operator, Internet TV operator, telco TV operator, switched digital video TV operator, video on demand operator.
Video—The related video, audio and data components that constitute:
   TV from a TV operator;
   Video from a playout device such as a consumer electronics device (e.g.: a VCR, DVD, DVR, PC with video output);
   etc
VPRD—Video Presentation and/or Recording Device—A device for presenting video signals to at least one person and/or for recording video signals (e.g. for later presentation). E.g.:
   for presenting: a TV Set, a TV display screen, a PC adapted to display TV, a handheld device capable of displaying video such as a PDA or cellular phone, etc.;
   for recording: a VCR, DVD-Write, DVR, etc.

### DETAILED DESCRIPTION OF PREFERRED EMBODIMENTS

Following is a detailed description of some preferred examples of carrying out the present invention.

According to one preferred embodiment of the invention there is provided a system for enabling display and/or recording of supplemented video signals at a subscriber premises, in place of externally provided video signals.

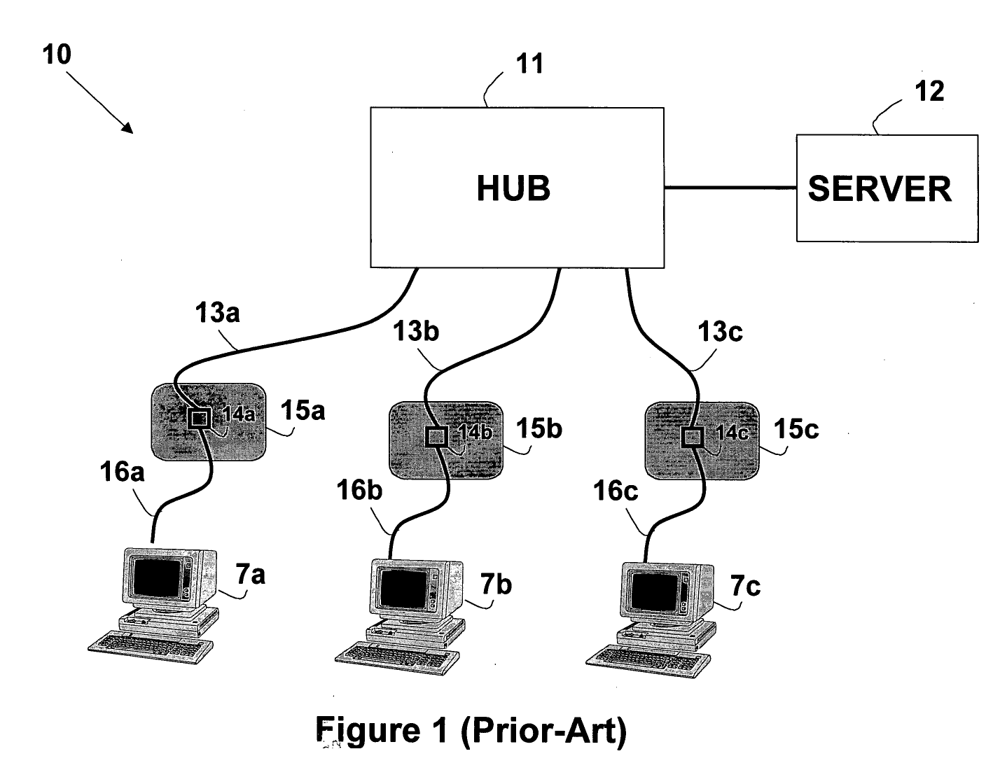

FIG. 1 presents a schematic illustration of an embodiment of a system according to the present invention.

In a preferred embodiment of the system, means 1 are operative to convey supplementation data (SD), programmer data (PD) and subscriber data (RD), from various sources including without limitation TV network programmers (6 and/or 9), their facilities (for example: programming points), their agents, subcontractors and suppliers (7) (for example: ad agencies, post-production facilities, ad distribution services), their customers (for example: advertisers), demographics data providers, market researchers and the like, to processing center(s) 16.

Means 1 typically comprise one or more wide area communications networks and services.

By another embodiment of the invention, processing center 16 is operative to store and process supplementation data, programmer data and/or subscriber data; create various appropriate derivatives thereof; forward the derivatives to appropriate subscriber devices 20 via transport means 14, possibly receive activity data and subscriber data from subscriber devices 20 via transport means 15, store and process said data, and prepare and calculate summaries, reports and results from said activities and data, such as bills, statements, viewing measurements and the like, for programming customers, subscribers and other parties, manage and monitor the distribution of such reports, bills and statements and the implementation of their ramifications accordingly (e.g.: collection of amounts due and distribution of rewards due).

In accordance with another preferred embodiment of the invention, transport means 14 are adapted to effect transport of part or all of supplementation data, programmer data and subscriber data from processing centers to subscriber premises, and may include one or more wide area communications networks and services in order to accommodate various types and quantities of transferred data, transfer requirements and costs, etc. Examples of such transport means are:
Radio datacast
TV datacast
Satellite datacast
Cable, Satellite or other TV distribution system including, without limitation, as data and as video, in dedicated channels and in shared channels
Cellular broadcast, multicast or unicast
Internet broadcast, multicast or unicast, by wired and wireless networks
Data network broadcast, multicast or unicast, by wired and wireless networks.

As will be appreciated by those skilled in the art, various other options that are not described above are known per se in the art and may be used to transport data from processing centers to subscriber devices. Nonetheless, they should be understood to be encompassed by the present invention.

By another preferred embodiment of the invention, transport means 15 are adapted to effect transport of activity data and subscriber data from subscriber premises to processing center(s), and may include one or more wide area communications networks and services, in order to accommodate various types and quantities of transferred data, transfer requirements and costs, etc. Examples of such transport means are:
PSTN (telephone network)
Cellular network
Internet by wired and wireless access
Data network by wired and wireless access.

As will be appreciated by those skilled in the art, various other options that are not described above, are known per se in the art, and may be used to transport data from subscriber devices to processing center(s). Nonetheless, they should be understood to be encompassed by the present invention.

In accordance with yet another preferred embodiment of the invention, the system further comprises transport means 17 adapted to allow transport of part or all of supplementation data, programmer data, subscriber data and activity data between transport means 14 and/or 15 and/or the network associated therewith and subscriber premise device 22. Preferably, transport means 17 include one or more local area communications networks and services (LANS), in order to accommodate various types and quantities of the data transferred, transfer requirements and costs, etc. Examples of such means are LANs of various technologies operating over:
premise telephone wiring
premise coaxial wiring
premise electricity wiring
wireless.

Preferably, subscriber device may include partial or full LAN capabilities integrally within it.

As will be appreciated by those skilled in the art, various other options that are not described above are known per se in the art and may be used to transport data in the premises. Nonetheless, they should be understood to be encompassed by the present invention.

As will be appreciated by those skilled in the art, the use of transport means 17 may be avoided in cases where the signals conveyed via transport means 14 and 15 directly reach subscriber device 22; e.g., if so desired: in the case that datacasting is used as transport means 14 and subscriber device incorporates a suitable receiver adapted to receive datacasting transmissions, while cellular dial-up is used for the signals conveyed by transport means 15 and subscriber device incorporates a suitable mechanism adapted to transmit signals appropriately for the applicable cellular network.

In addition, the system illustrated above may further comprise embedding means 2 that may be used by TV network programmers 9 to insert part or all of supplementation data, programmer data and/or subscriber data into the TV networks they assemble and/or change. Such embedding means 2 are operative to embed said data into the TV signal by various methods, such as in:
viewable video lines, perceptibly or imperceptibly e.g. as watermarks;
non-viewable video lines;
blanking intervals;
audio components, e.g.: as separate data and/or as watermarks;
data components.

As will be appreciated by those skilled in the art, various other options not specified above and are known per se in the art may be used to embed data in the TV signal. Nonetheless they should be understood to be encompassed by the present invention.

The TV signal, with said data embedded if any, may be transported to one or more additional (e.g. local) TV network programmers 6, in parallel (as shown in FIG. 1) and/or in series (not shown in this Fig.), who may add their content to the said signal and may embed, by embedding means 8, part or all of their supplementation data, programmer data and/or subscriber data into the TV signals they change.

Thereafter, said TV signal, with said data embedded if any, may be transported to one or more subscriber premises via a TV operator's system 10 (e.g.: a cable TV or satellite TV operator's system), typically multiplexed by the TV operator together with other TV signals, to a receiving means 22 (e.g.: an STB) located at the subscriber premises, which can, upon command, output said TV signal or other TV signal for subscriber usage.

Preferably, subscriber device 20 is operative in the subscriber premises to receive an external video signal from receiving means 22 (which device may be any typical consumer source of a video signal, including, without limitation, an STB, VCR, DVD, PVR, DVR, PC playing TV, game device playing video, and the like) and to receive supplementary data, subscriber data and programmer data in whole or in part via the said TV signal and in whole or in part via transport means 14 and/or 17 if used, and to incorporate supplementary content into said TV signal in accordance with the data received and certain algorithms applied, and to output the so-supplemented TV signal for subscriber's use. In addition, subscriber device may be operative also to report to processing center 16, via transport means 15, these supplementation activities and certain subscriber activities.

As would be appreciated by those skilled in the art, transport means 1, 14 and 15 may be totally separate from each other or partially or completely integrated.

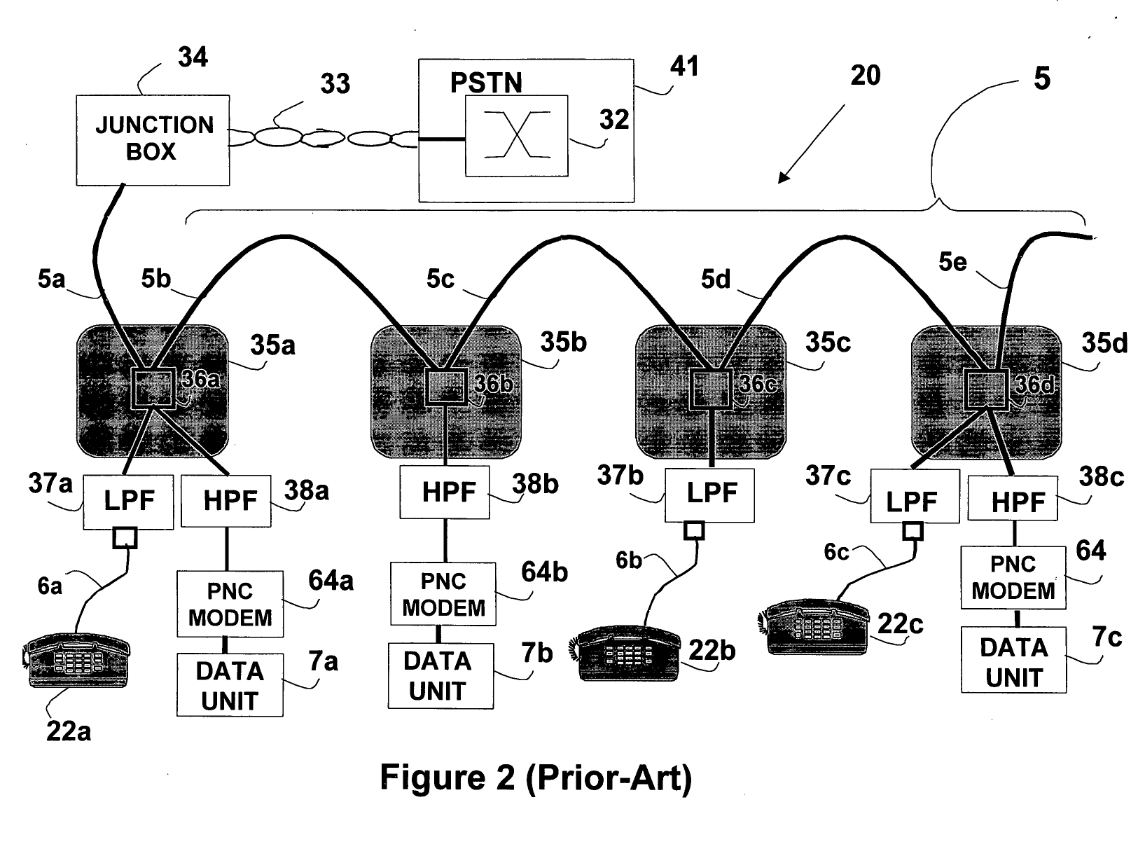

FIG. 2 presents a schematic detailed illustration of a subscriber device 20 shown in FIG. 1.

Device 20 described in this embodiment is adapted receive an external video signal (EV_S). This external video signal is typically received from receiving means 22 (which is not part of this embodiment of the invention). Means 22 could be for example, a Set Top Box (STB), a consumer electronics device that records or plays out TV.

The EV_S can be in any format supported by typical consumer TV presentation or recording devices, such as, analog or digital, component or composite, standard-definition or high-definition, interlaced or progressive, uncompressed or compressed and other formats which may be invented from time to time and supported by typical consumer TV presentation or recording devices.

The external video signal (EV_S) may also carry “in-band” (i.e.: embedded within it) at least some information which is part of the supplementation data, subscriber data and programmer data.

Device 20 described in this embodiment comprises a probe 24 that is operative to monitor the EV_S and to detect, extract, possibly convert as appropriate and forward to input data handler 34, any in-band information carried in the EV_S. Such extraction is essentially the functional inverse to the embedding operations described above.

In the alternative, probe 24 may operate as a splitter or duplicator, whereby part or all of the signal, respectively, that reaches this probe is conveyed, with or without amplification, towards incorporation means 26, while part of the EV_S is diverted, with or without amplification, towards input data handler 34.

Preferably, probe 24 is adapted to allow a transparent pass through of the signal received towards incorporation means 26 in case of pre-defined malfunctions of device 20, power loss, and the like.

In addition, device 20 described in this example further comprises means 30 adapted to receive supplementation data, subscriber data and/or programmer data from outside the EV_S (“out-of-band”), e.g. from one or more processing centers and/or programming customers' facilities, agents and/or suppliers, over the appropriate transport described herein. Furthermore, such means 30 may comprise more than one of the abovementioned means, particularly, for different types of data (for example: means for receiving programmer data from the Internet, while other means may be used for receiving supplementation data e.g. TV datacast), and/or for decreasing the risk of information loss (improving survivability).

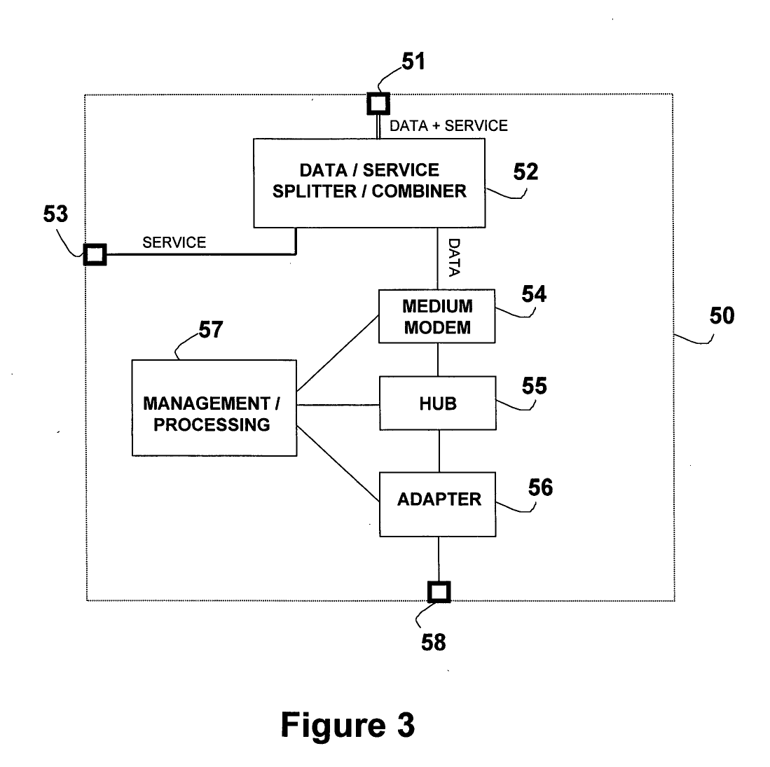

Device 20 described in this example comprises input data handler means 34 adapted to extract, decipher, select, convert (including, without limitation, compress, decompress, transcode, transrate, reformat) and prepare for storage, data received by means 30, received via means 24 and if applicable, received by means 32 (not shown in this Fig.) described in connection with FIG. 3.

Device 20 described in this example further comprises storage means 28 adapted to store data prepared by means 34 and if applicable, by logging means 42 described in connection with FIG. 3.

Storage 28 may include any storage means commonly used in consumer electronics devices and personal computers (or that will be commonly used in the future), including, without limitation: hard disk drive, micro hard disk drive, optical disk (CD, DVD, etc), FLASH memory, secure digital memory, RAM in all its forms, and the like. Storage means 28 may also comprise several different means, as each of which has certain attributes such as capacity, cost, read speed, write speed, volatility, etc. The information is stored in various parts of storage means 28 in accordance with the characteristics of the various types of storage, the attributes of the information to be stored, and the expected usage mode of said information. For example, SO_A may be stored in volatile storage, since in some embodiments its lifespan is short (i.e.: seconds or minutes), it is typically used once, and rare loss of all SO_A has little importance (since superceding SO_A is typically frequently received from outside device 20), while SC is preferably stored in non-volatile storage since its lifespan is typically long (i.e.: days or weeks from receipt of SC until its total usage), it is typically used repeatedly, and loss of all SC would typically require a high-volume download, whose duration could be long.

Device 20 further comprises processor(s) 36 adapted for making decisions, in a manner that enables timely execution, when to incorporate SC into the EV_S and what SC to incorporate at that time, dependent on various subsets of the information stored (e.g. supplementation data, subscriber data, programmer data and activity data), and algorithms appropriate to each subset, and for retrieving a copy of SC from storage accordingly, adapting it for incorporation as appropriate (e.g.: converting from storage format to the appropriate SEV_S format) and for staging said copy in staging means 40 for incorporation by means 26. Alternatively, this staging means may be a part of storage means 28 and may be a logical preformed action rather than a physical device.

Device 20 comprises incorporation means 26 adapted for timely re-validation of the decision to incorporate the SC stored in staging means 40 into the EV_S, for carrying out said incorporation if the decision is found to be valid, for conveying the so-supplemented external video signal (SEV_S) to the output port of device 20, towards VPRD means 11, and for logging these activities by logging means 42 if used. Preferably, incorporation means 26 is adapted to allow transparent pass through of the signal received towards VPRD 11 in case of pre-defined malfunctions of device 20, power loss, and the like.

FIG. 3 describes some further options that may be incorporated within device 20 of FIG. 2.
Means 32 operative to enable receiving signals from local sources (such as signals from which subsets of subscriber data may be derived, including without limitation from an apparatus that deduces subscriber data by analyzing viewing habits) and from a local input device that is adapted to transfer signals from a subscriber (or other people). Preferably, subscriber device supports calibration by various means to enable it to use said signals, an example for a method of such a calibration is: the subscriber device inserts into the SEV_S supplementary content that causes displays onscreen of the commands that it needs to recognize, and the subscriber presses appropriate buttons on the LID for each—whereupon the subscriber device calibrates itself accordingly. The subscriber device preferably logs inputs so received (e.g.: for subsequent click-stream analysis);
Means 34 described above in connection with FIG. 2, may further comprise means for processing subscriber's responses to the EV and supplementary content and requests to affect the latter;
Logging means 42, adapted for capturing data about supplementation activities, subscriber device activities, subscriber activities and certain measuring activities (such as “VPRD condition” and “viewer presence” and the like) performed by or via the subscriber device, and having them recorded, along with appropriate data (such as time stamp, activity code) in an appropriate manner in storage 28. The logging means, if incorporated, preferably enable retrieval of data logged in a manner appropriate to its usage by the subscriber device in making decisions in a timely manner; e.g.: to take into consideration the incorporation history of SC when selecting the SC for incorporation at a supplementation opportunity;
Report generator 48, adapted for generating reports comprising pertinent activity data and/or subscriber data and/or measurement data and/or derivatives thereof for delivery to processing centers, and optionally for constructing a signal or signals for carrying said data;
Means 50 adapted to transmit signals constructed by the report generator 48 towards one or more processing centers, using transport means described herein;
Conversion means 52 adapted to operate on the signal received from probe 24 so as to convert the EV_S from its input format to a desired output format, based on pre-determined parameters, in which case, conversion means 52 preferably supports conversion between any pair of formats supported by the EV_S. Preferably, conversion means 52 is adapted to allow transparent pass through of the signal received towards VPRD 11 in case of pre-defined malfunctions of device 20, power loss, and the like;

Detection processor(s) 54 is adapted to process data received from one or more sensors and/or detectors not shown in the Fig. and associated with subscriber device 20 (e.g. IR detector, thermal detector, etc.), data which relate for example to the following: whether a viewer is present adjacent to the VPRD 11; whether a VPRD is connected to the subscriber device and is active; whether a source device 22 is connected to subscriber device and is active; etc.

In addition to the above, the subscriber device may further include management, control, administration and maintenance means such as the following (not shown in this figure):

means for ensuring the integrity, security and authenticity of all the signals received and transmitted by subscriber device 20; and/or

means for ensuring the integrity and/or security of the data stored; and/or

means for erasing from local storage elements of data that are no longer used in ongoing processing in accordance with prescribed data retention and maintenance requirements and procedures; and/or

means for managing and administrating the subscriber device and the activities performed therewith.

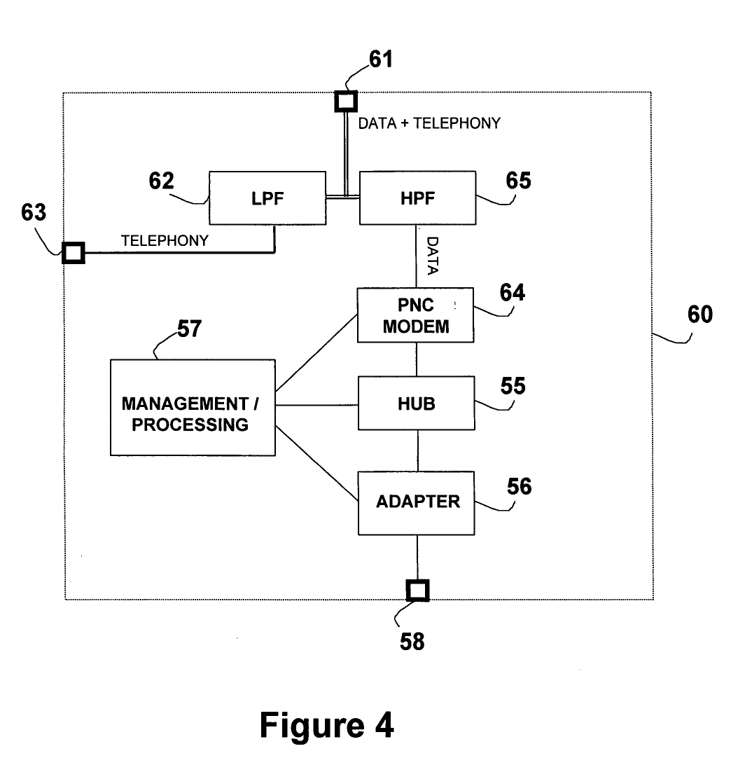

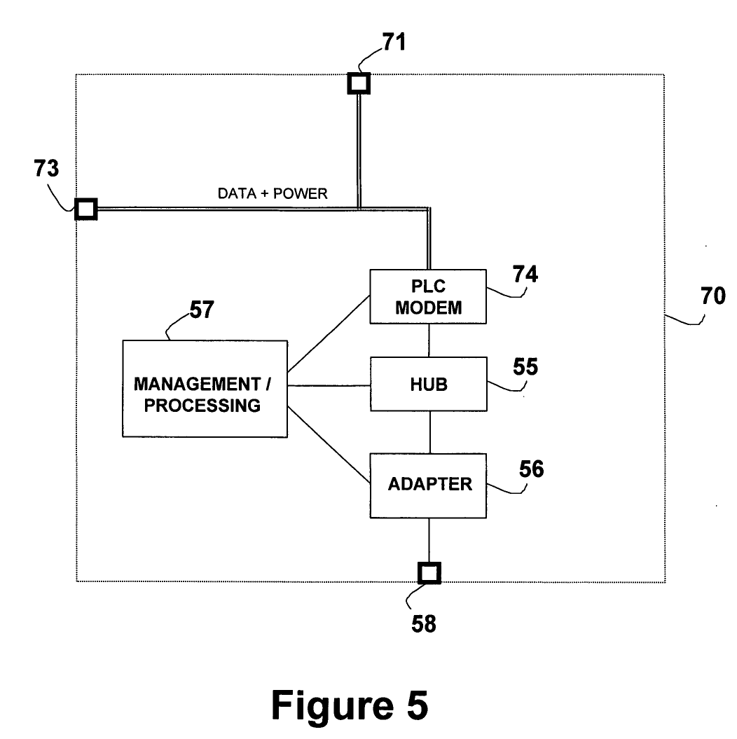

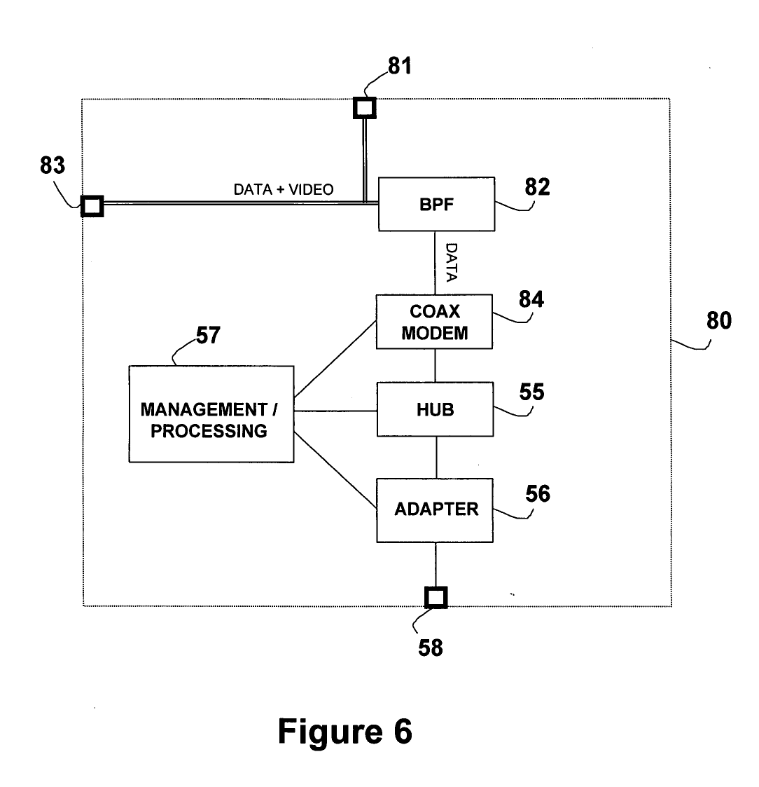

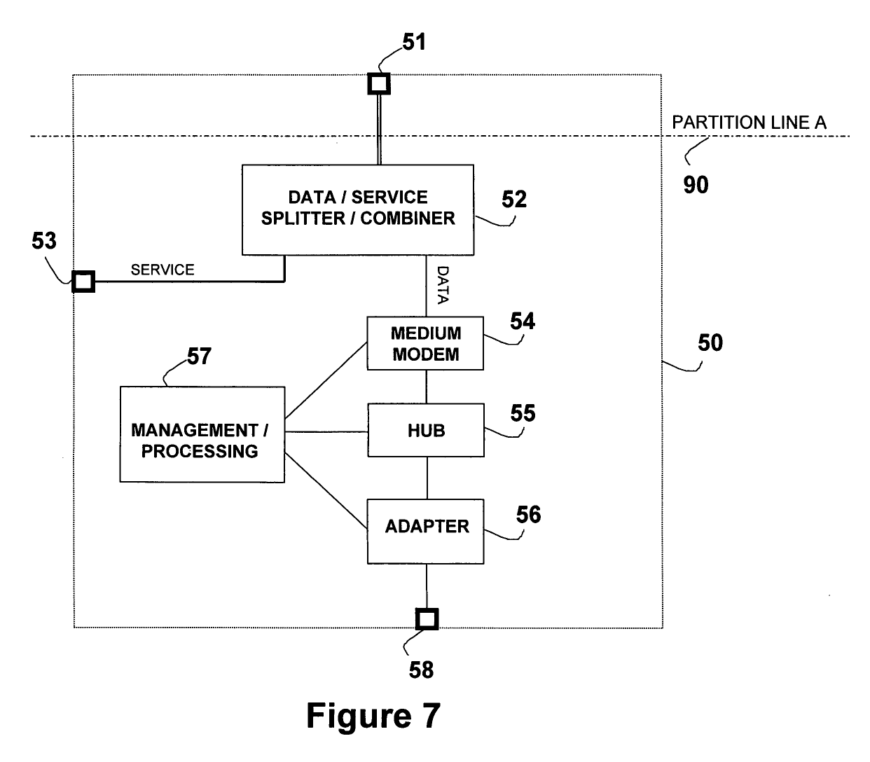

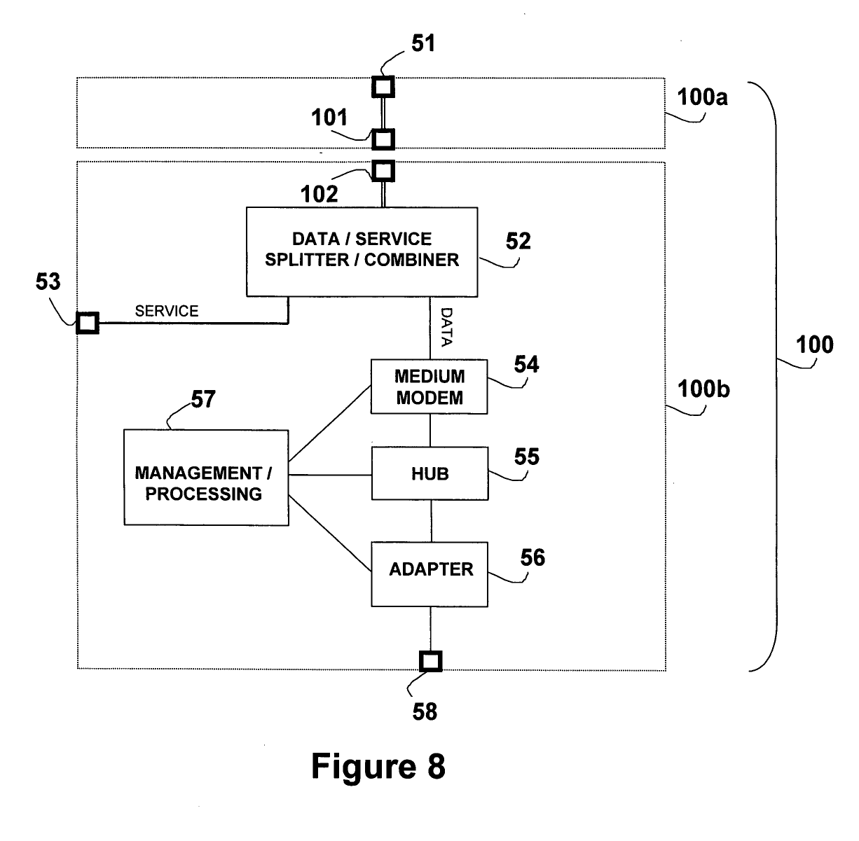

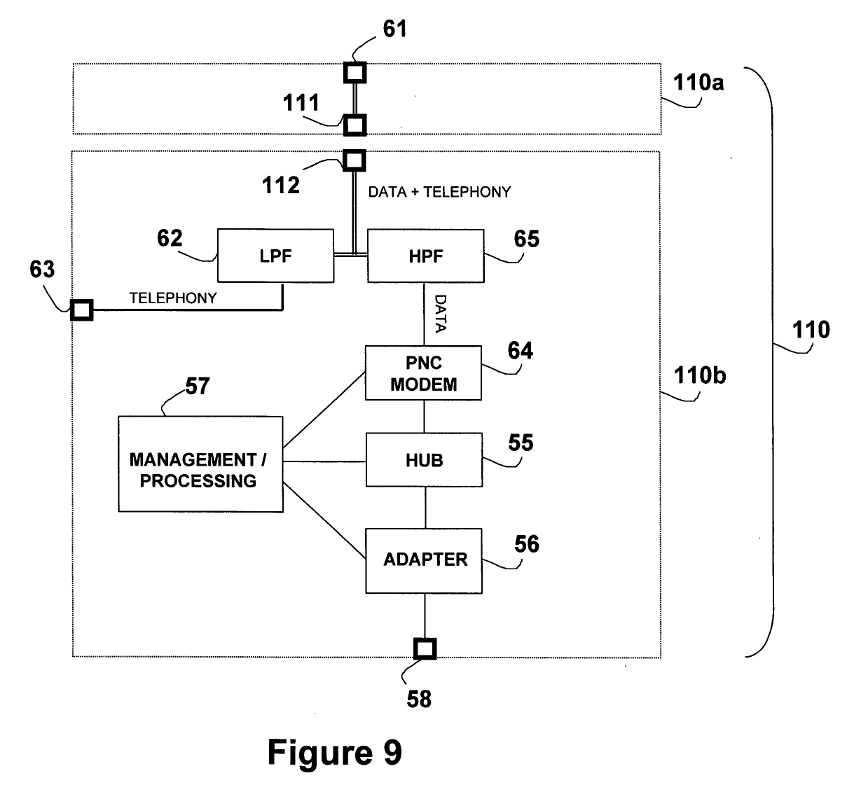

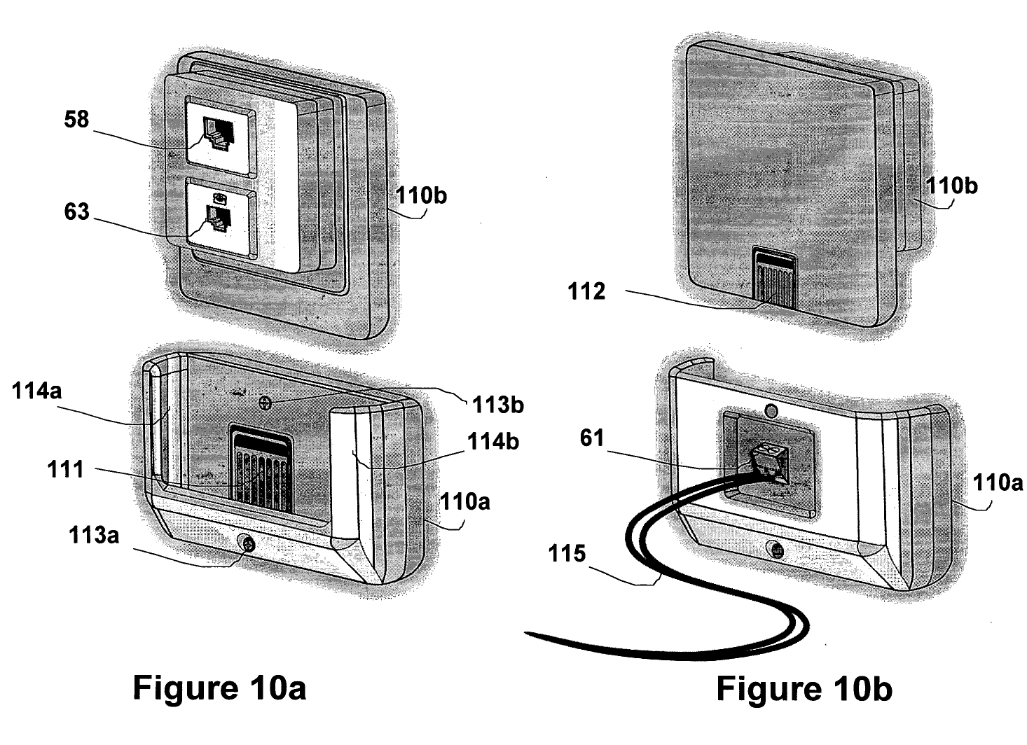

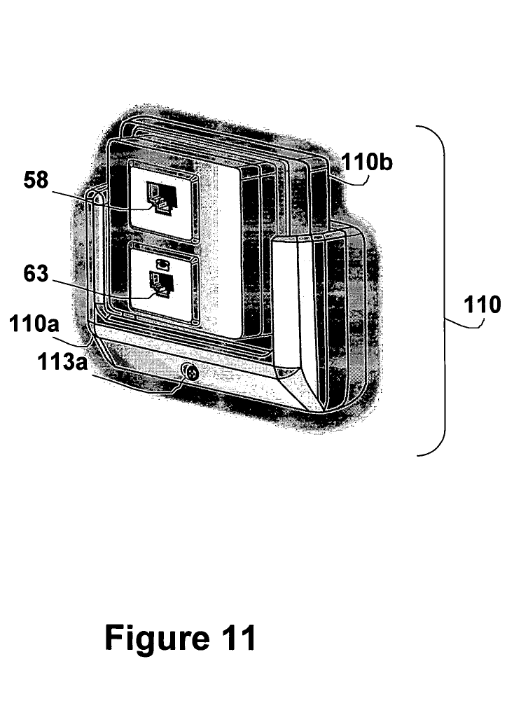

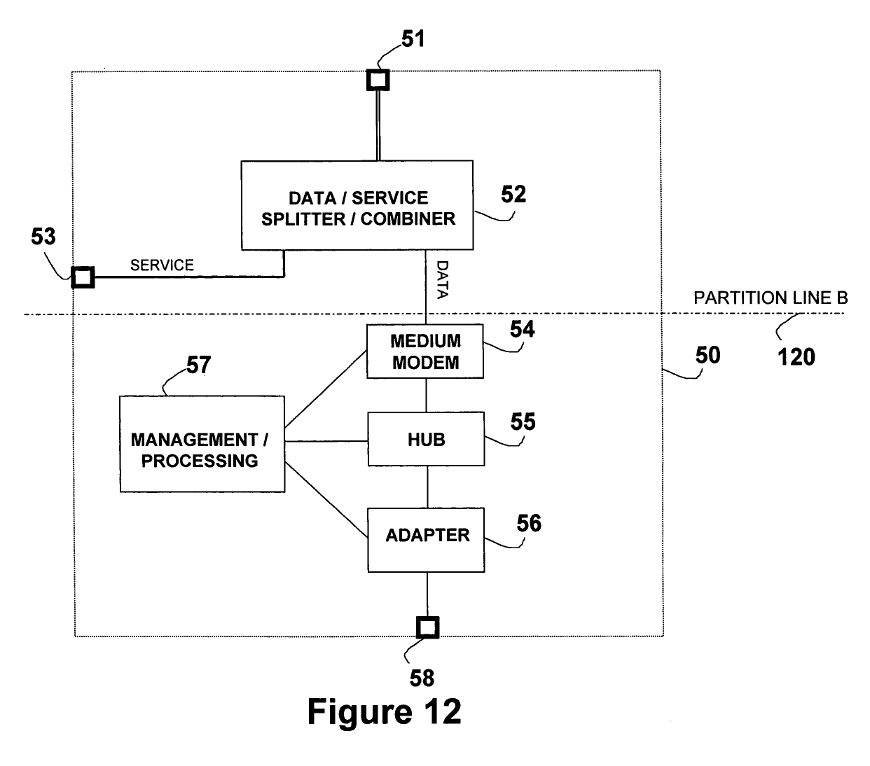

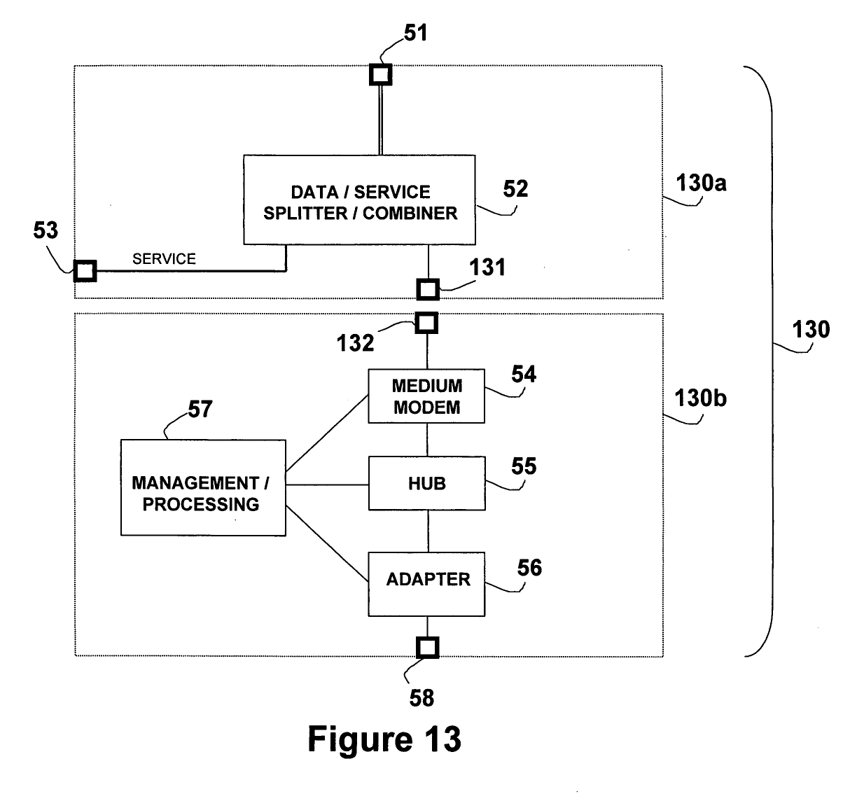

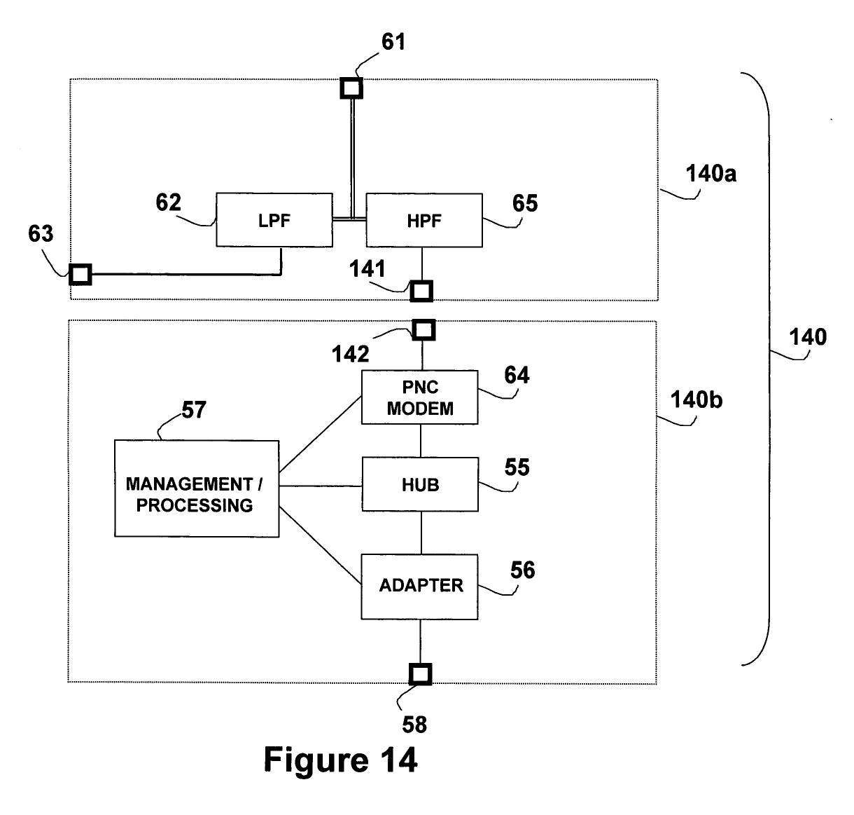

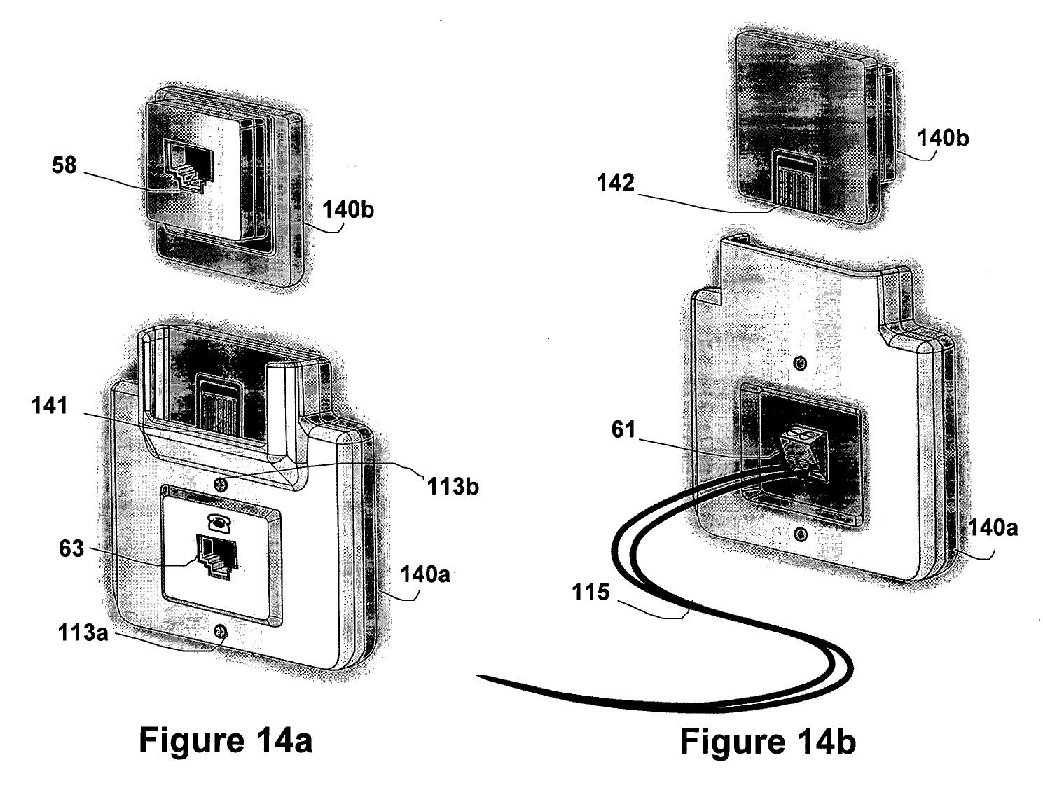

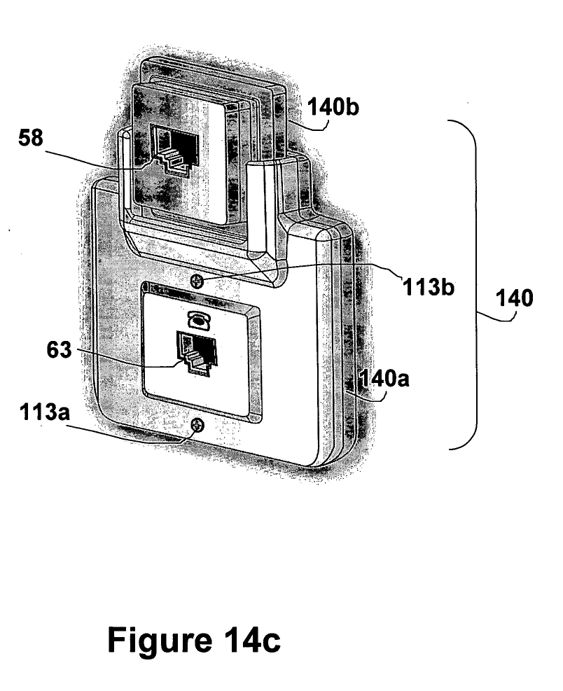

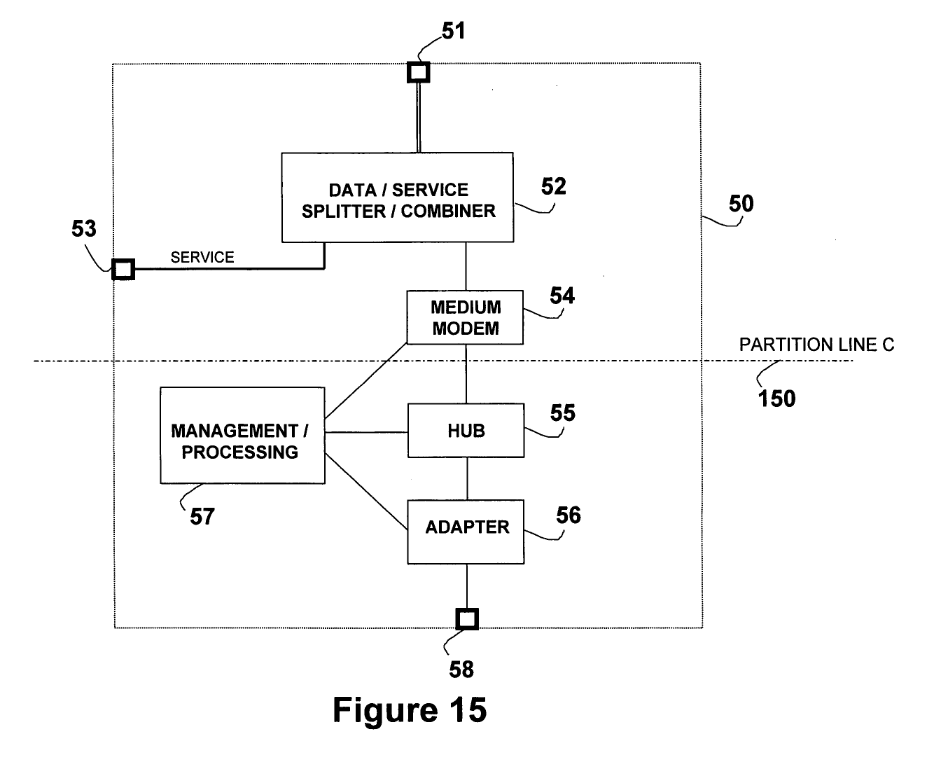

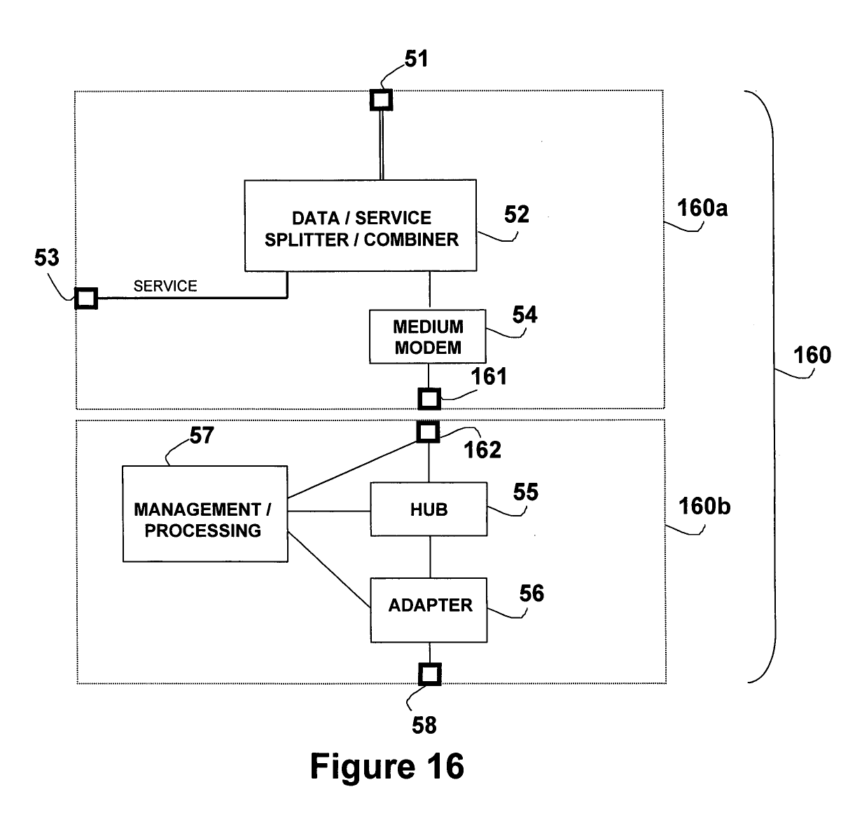

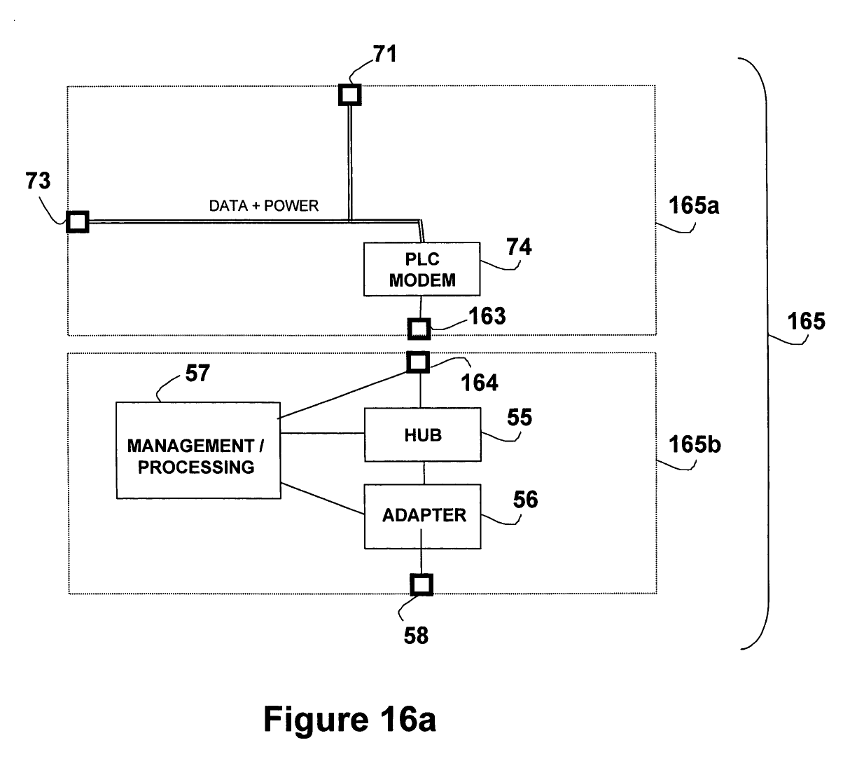

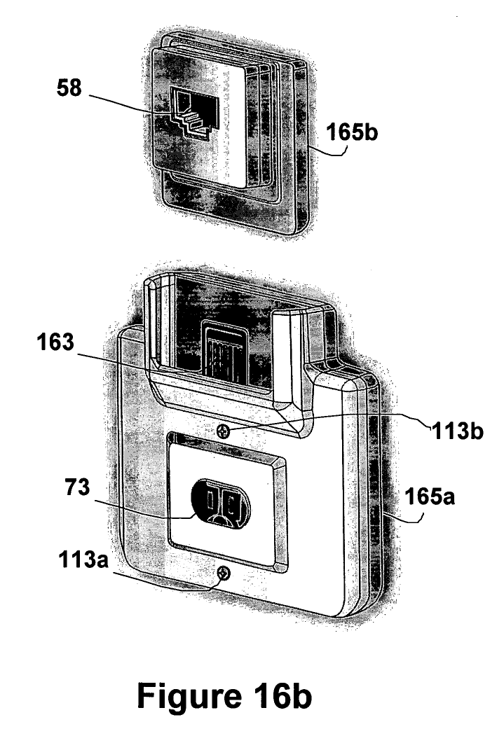

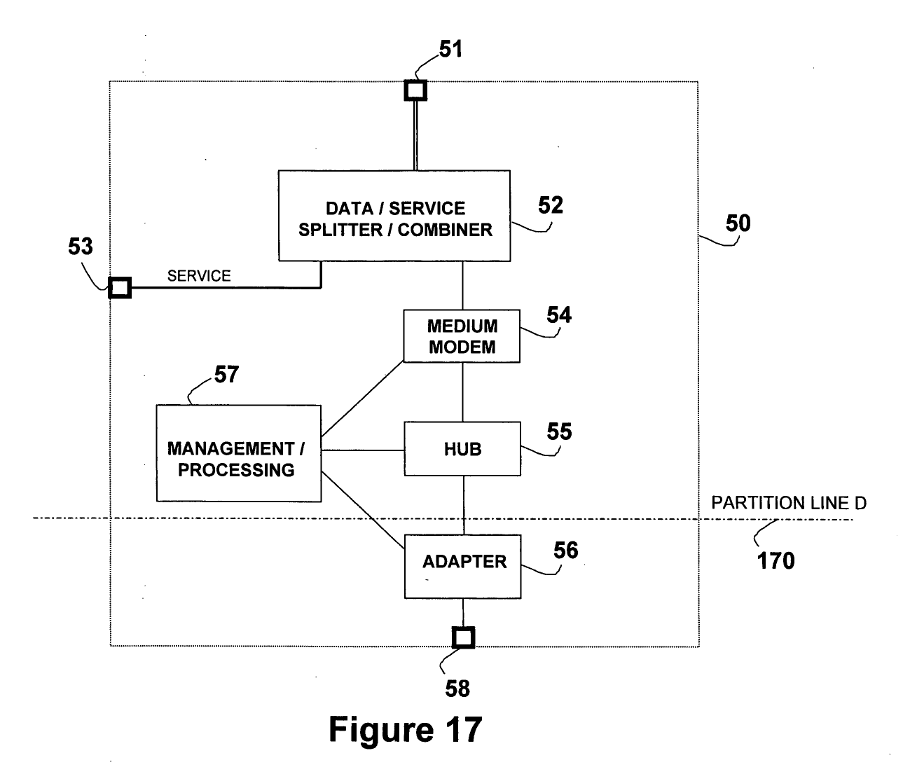

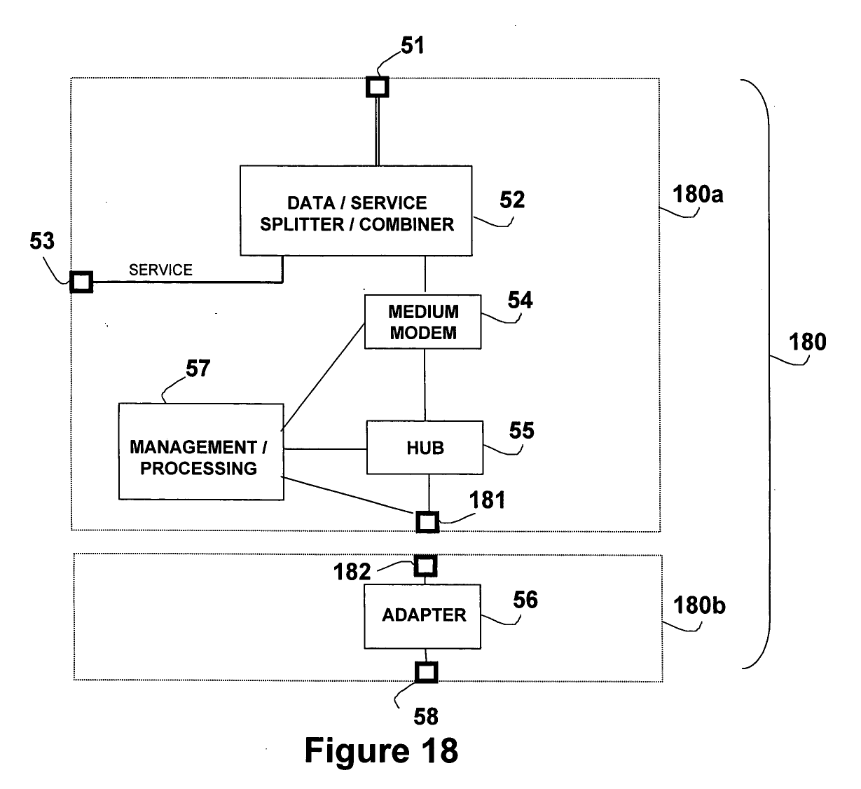

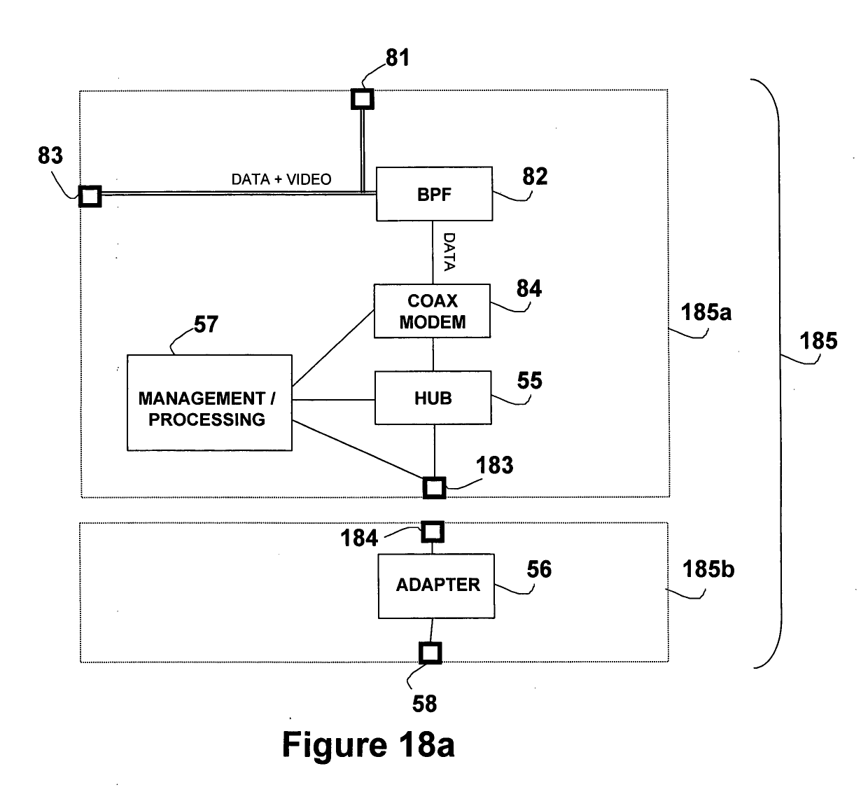

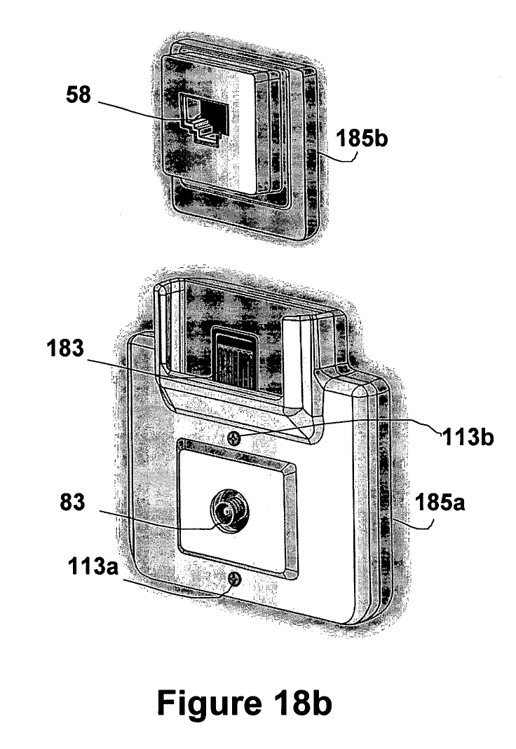

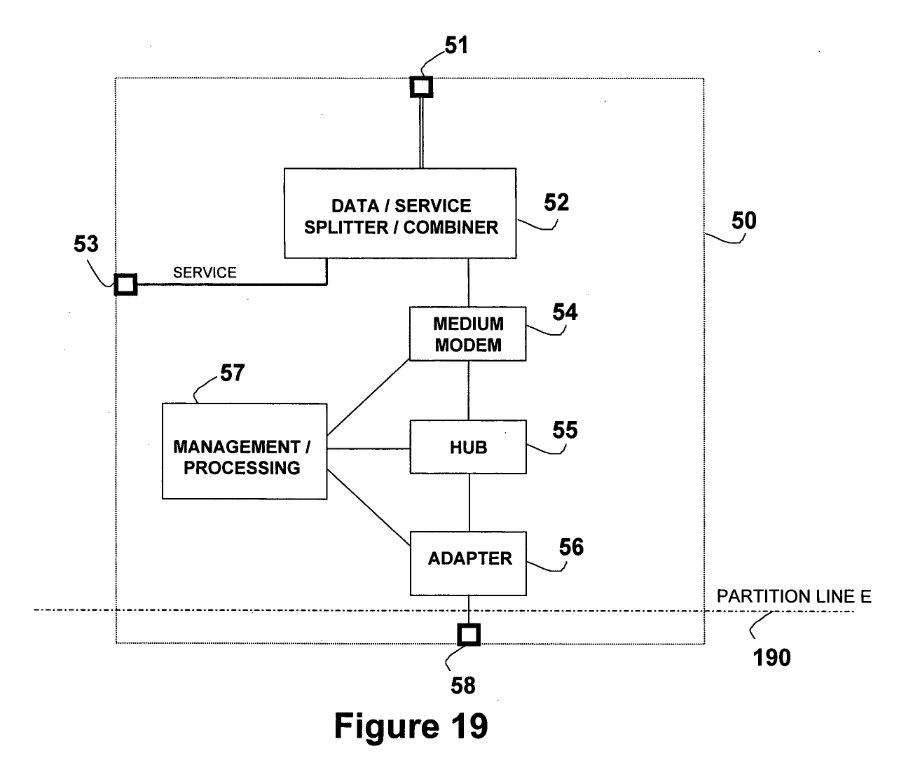

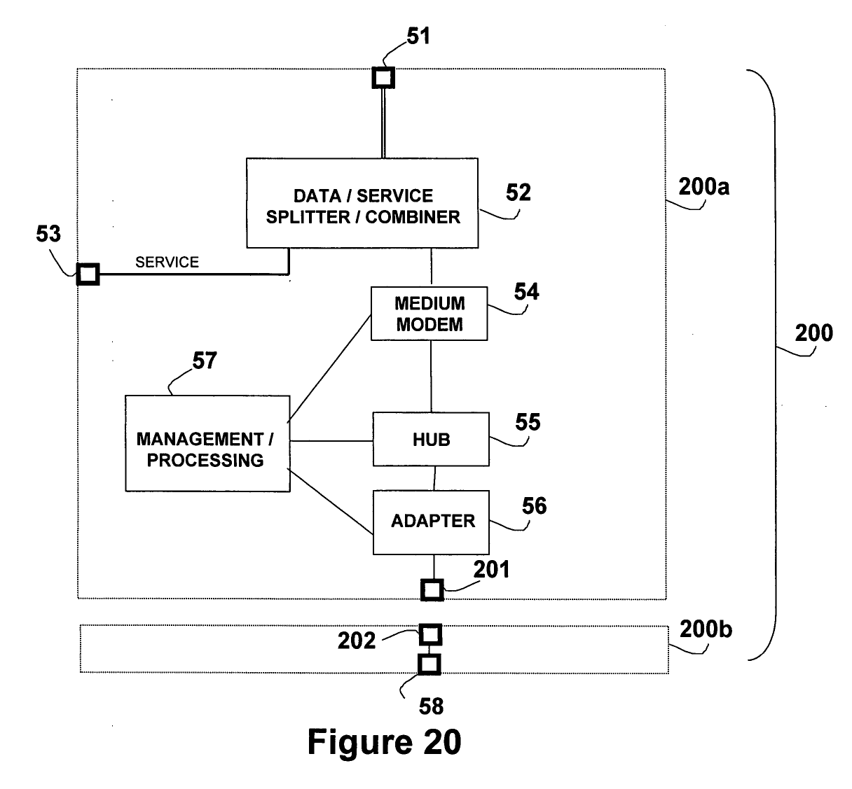

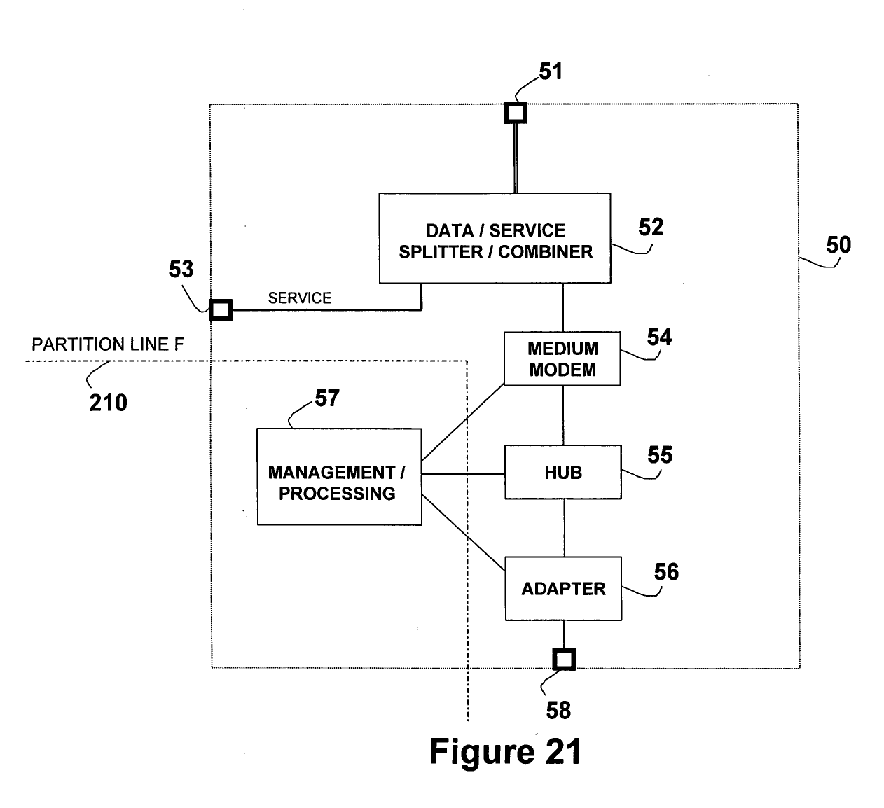

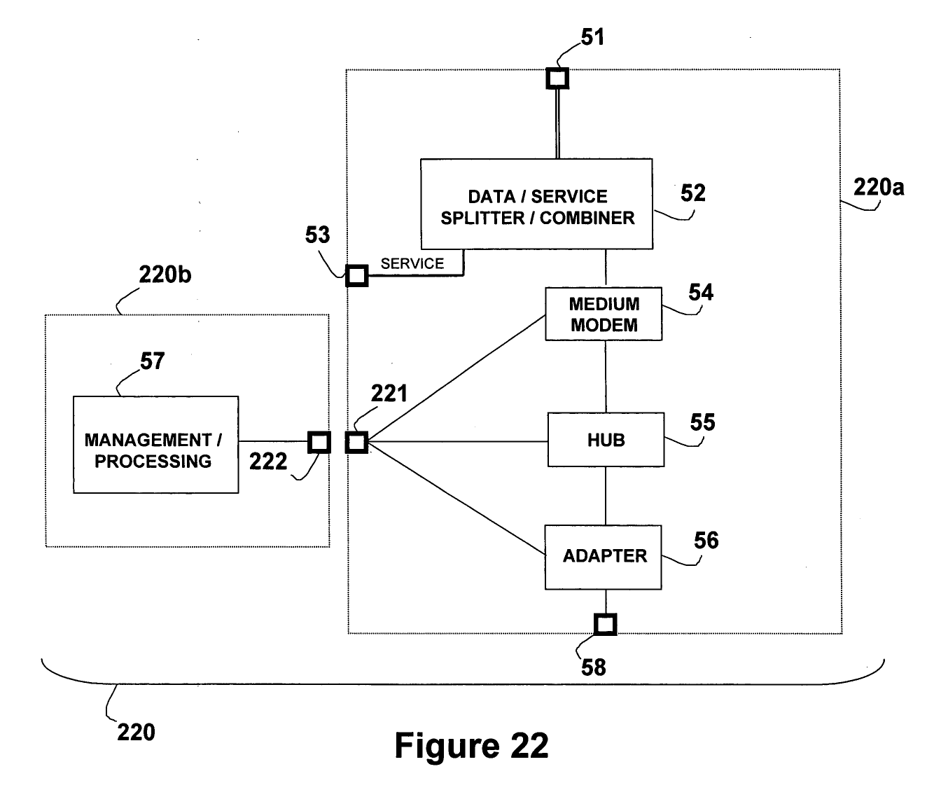

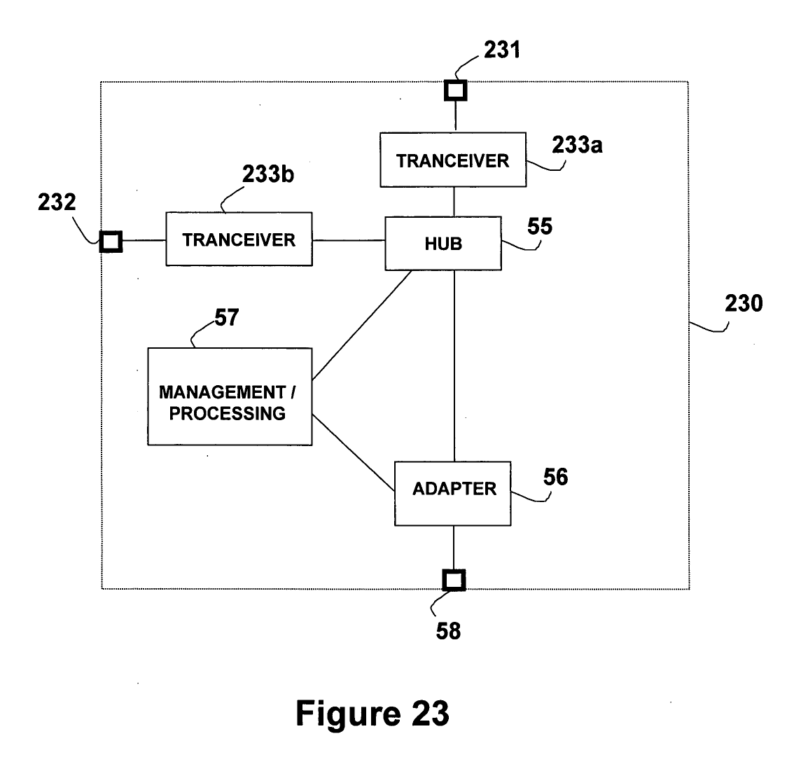

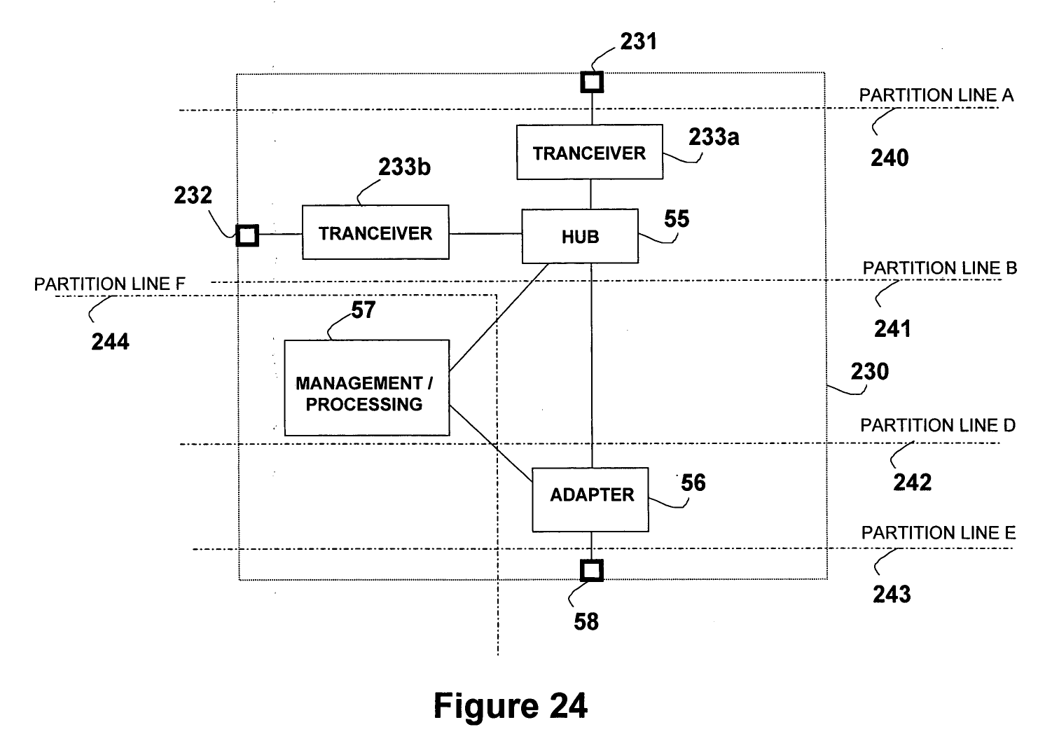

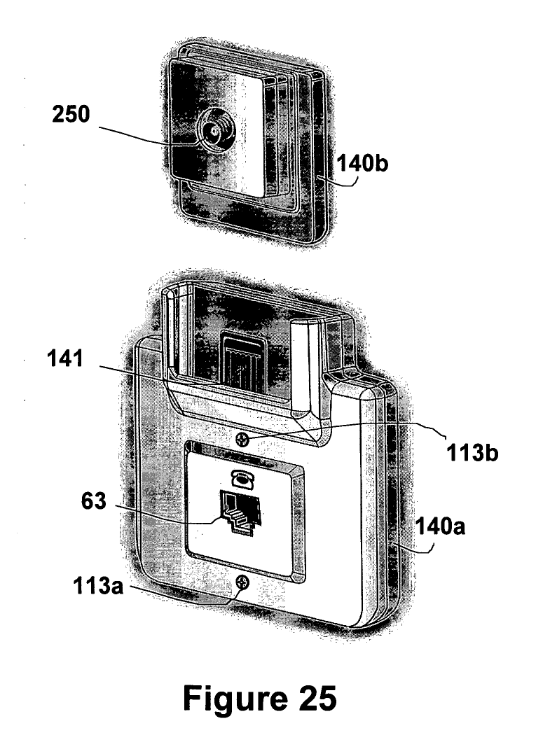

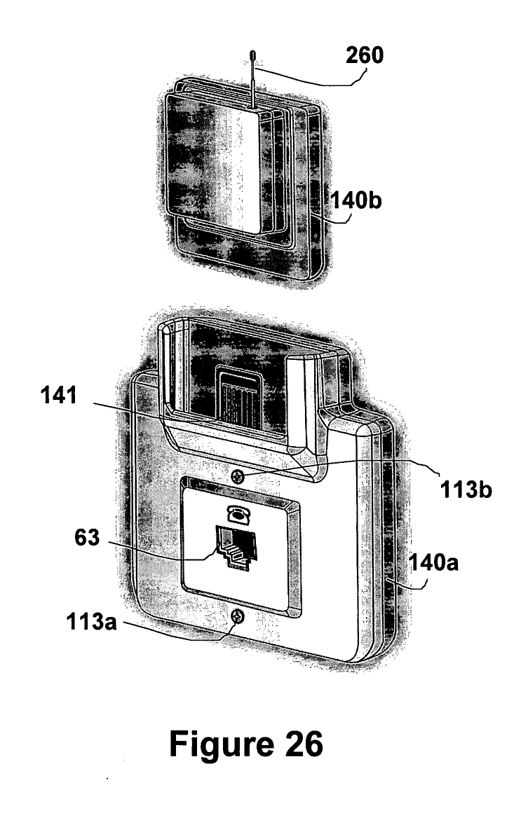

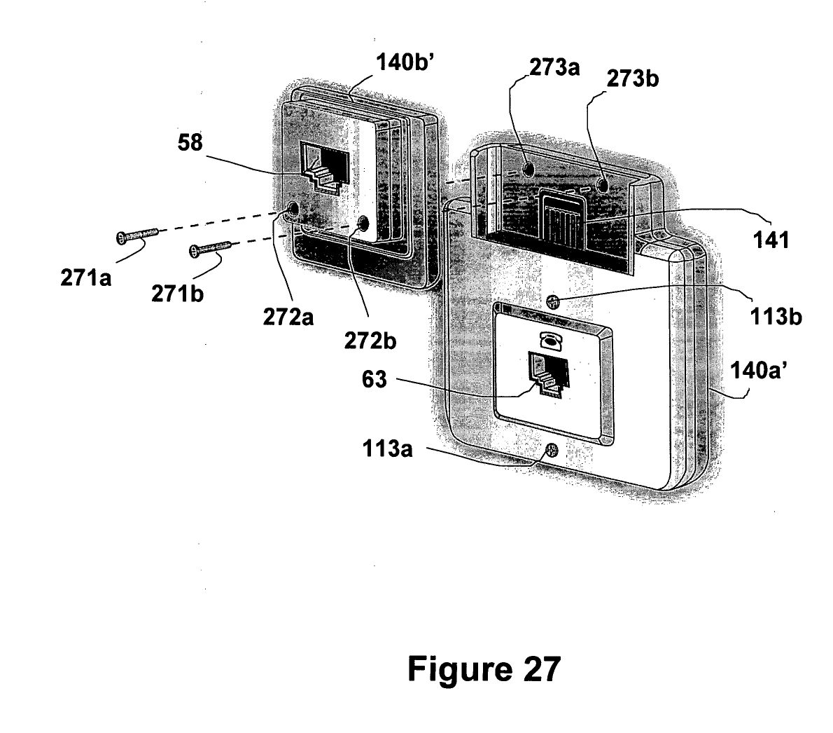

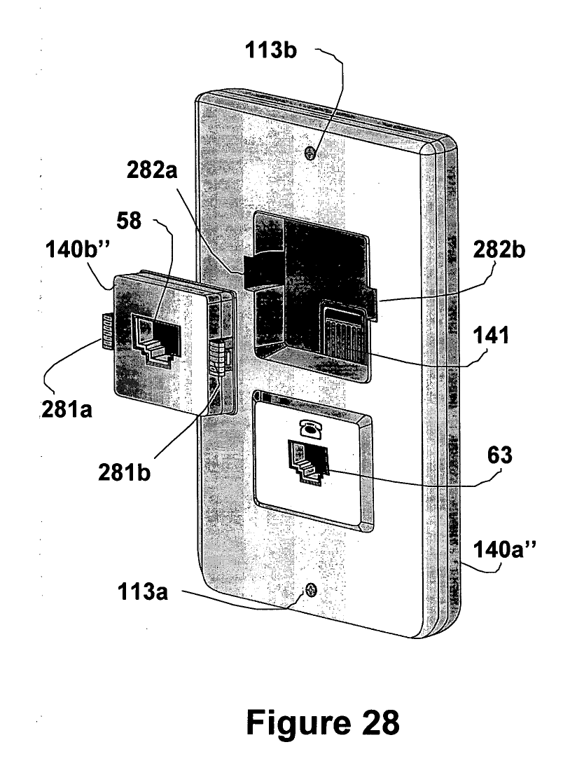

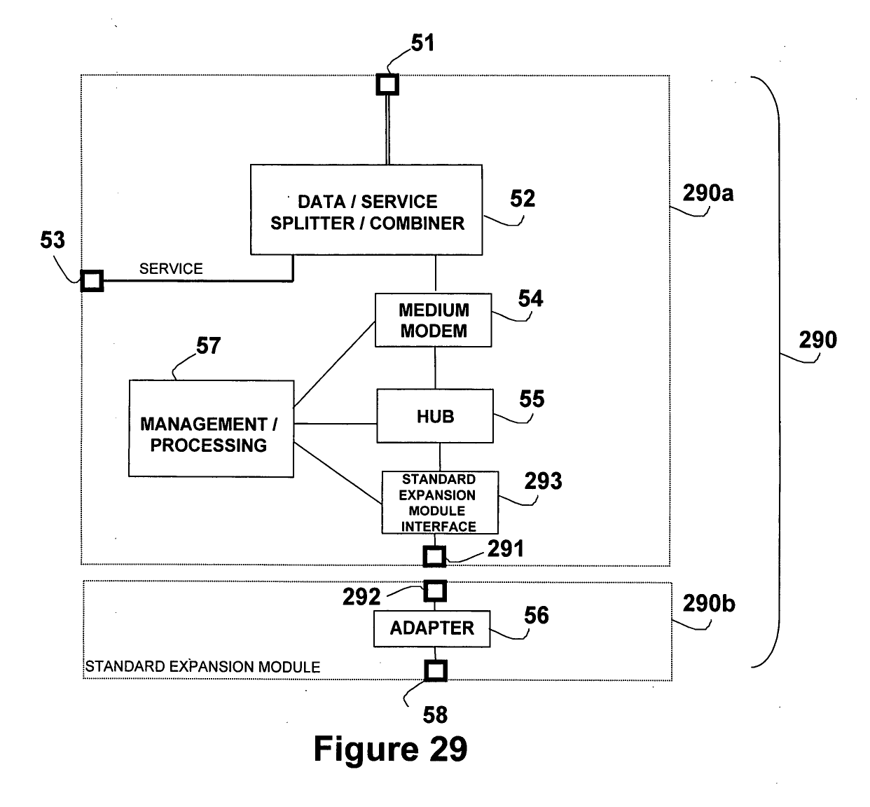

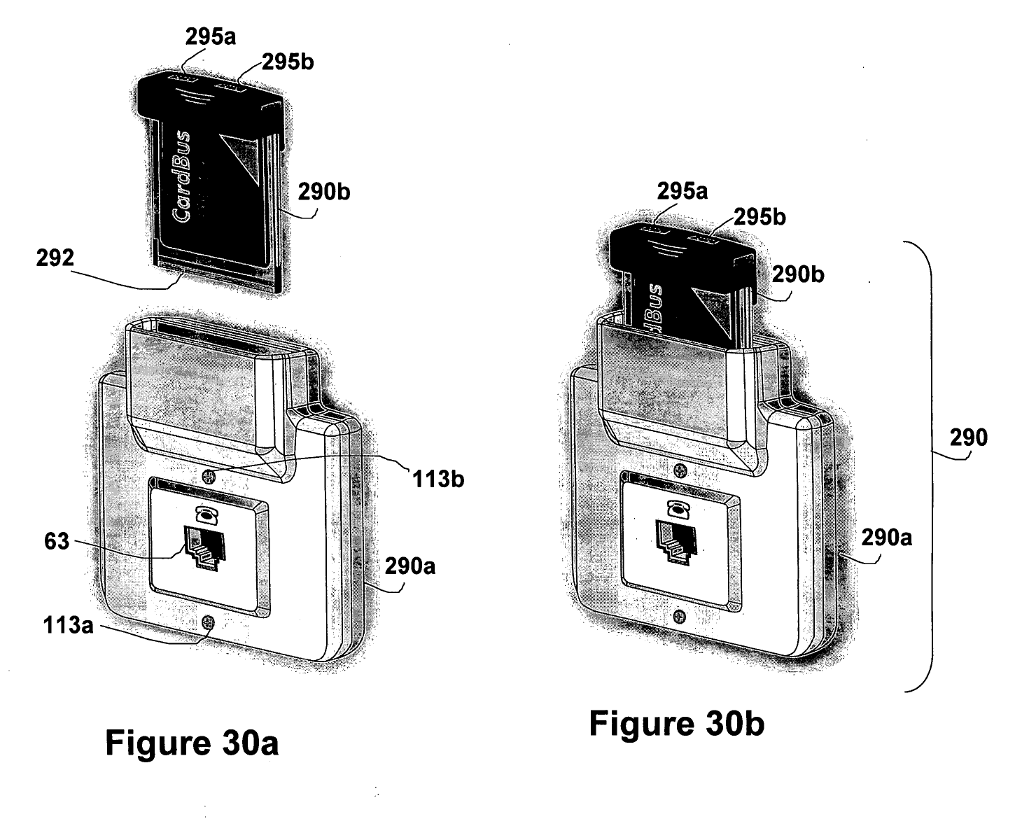

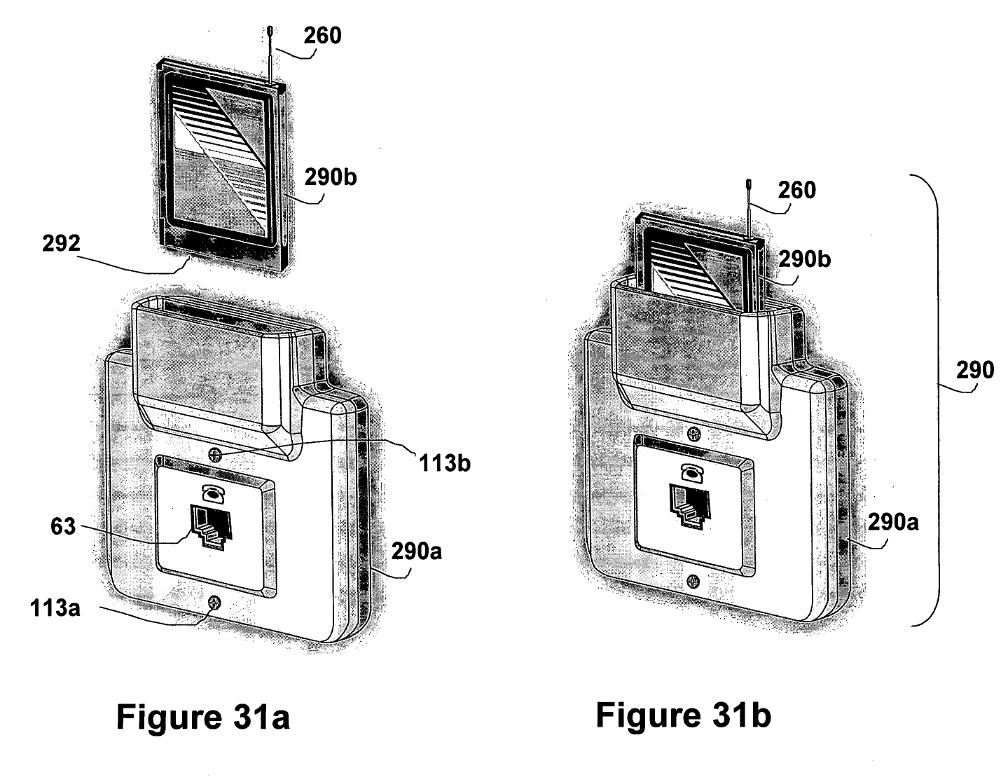

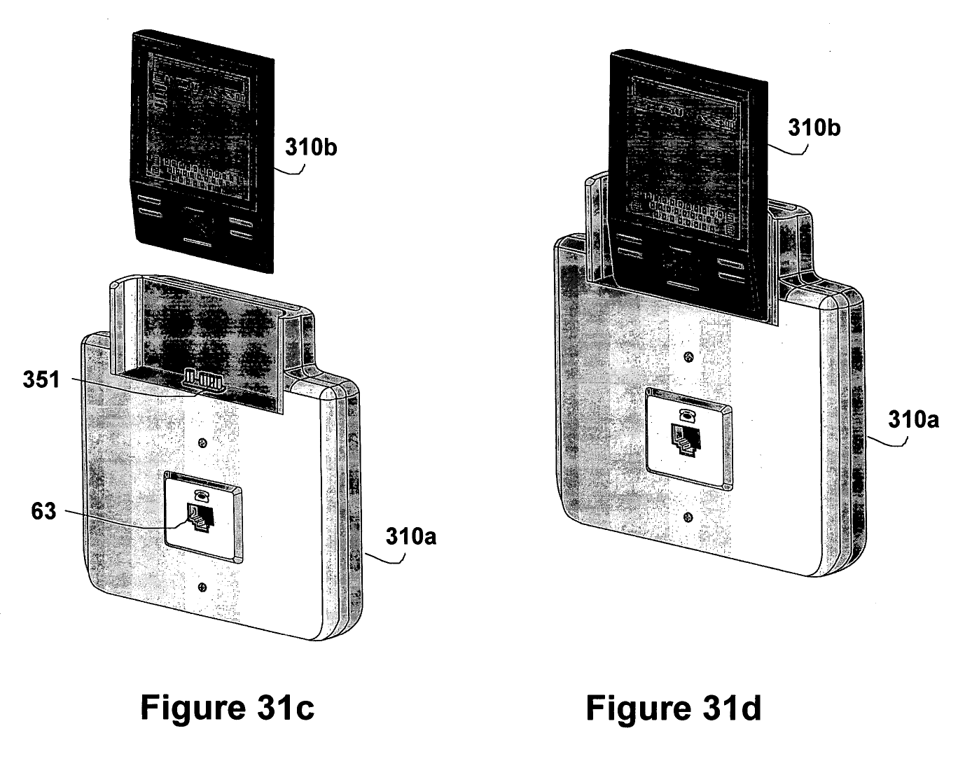

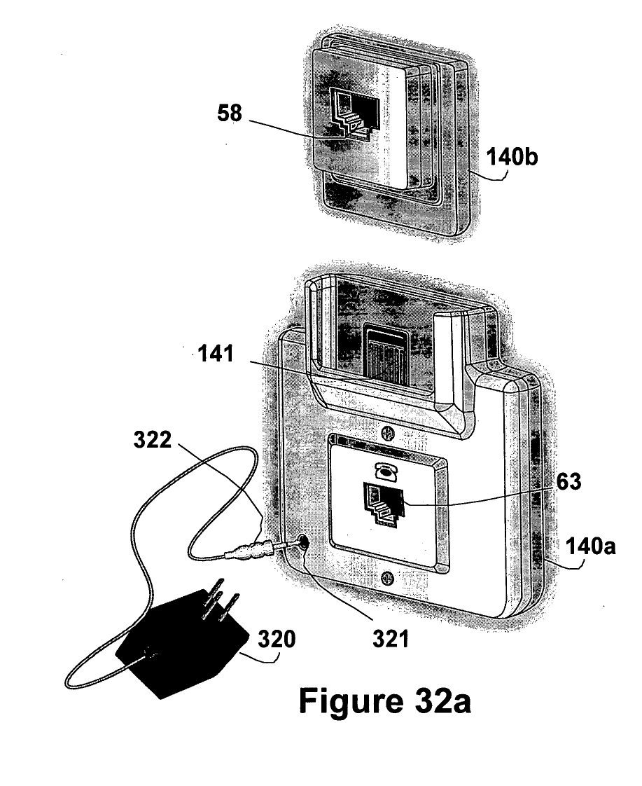

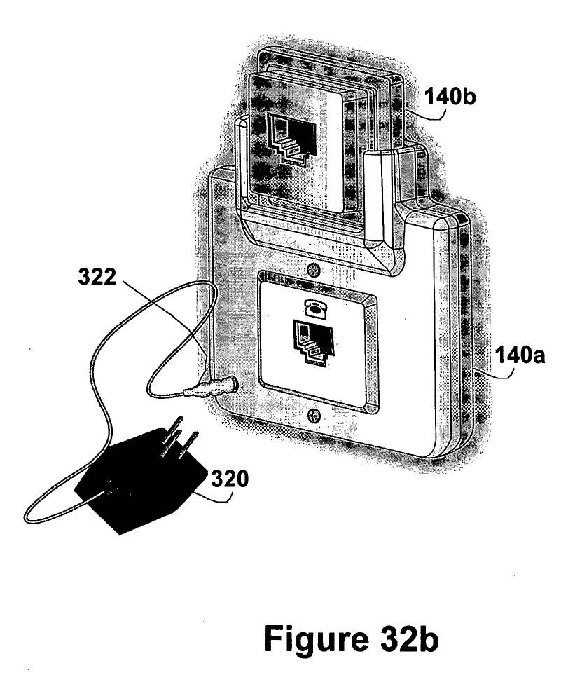

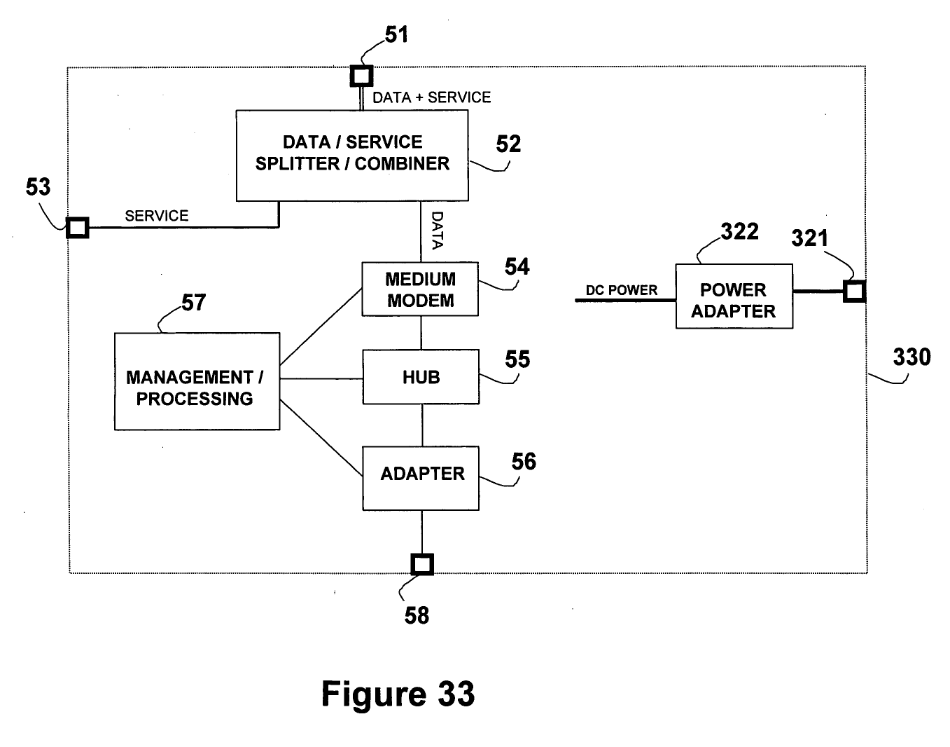

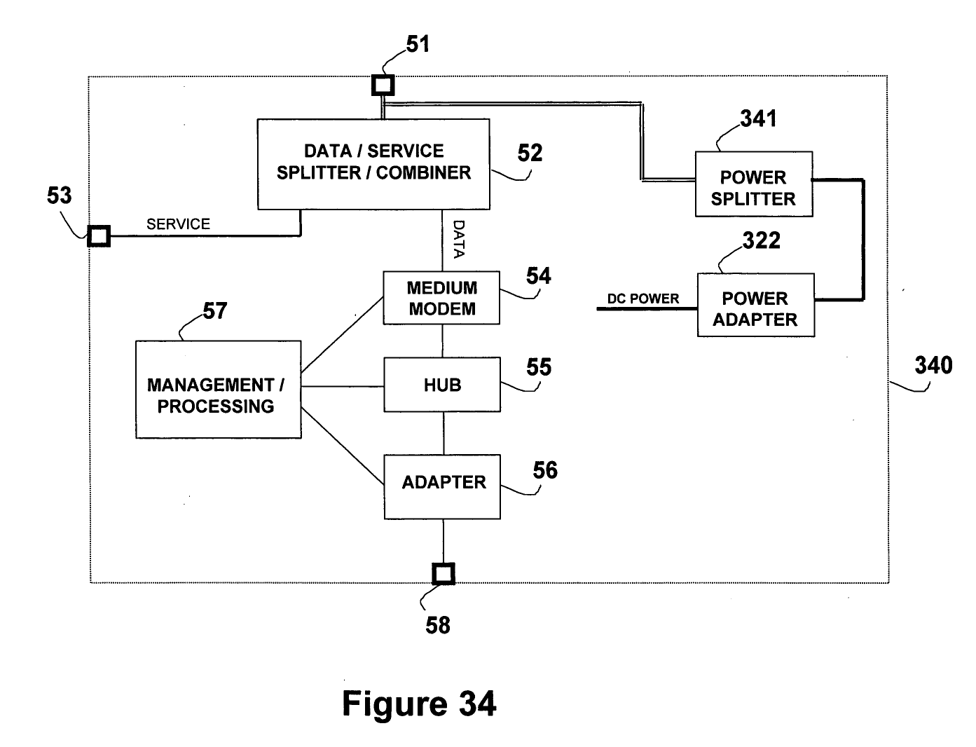

FIG. 4 is a flow chart diagram of a non-limiting example, demonstrating a method of implementing the present invention at the subscriber's premises.

The method comprising essentially the following steps:
a. Receiving an external video signal (step 100);
b. Receiving supplementation data, subscriber data and programmer data and storing said data in a manner appropriate for each item of data (step 110);
c. Retrieving data pertinent to incorporation of supplementary content from said the stored data and determining, in accordance with the retrieved data, the supplementation content for incorporation into the external video signal (step 120);
d. Retrieving and incorporating supplementary content, selected in the previous step, into the external video signal to create a supplemented external video signal (step 130);
e. Forwarding the supplemented signal to the output port (step 140).

A further description of some of these steps is provided herein:

b. Receiving Supplementation Data, Subscriber Data and Programmer Data and Storing said Data in a Manner Appropriate for Each Item of Data (Step 110)

Supplementation Data (SD) consists of any or all the members of the group comprising of EV_A, SO_A, SC, and SC_A, and/or parts thereof, which are described hereunder.

External Video Attributes (EV_A):

The EV_A information relates to at least one EV and may be used, among other uses as described herein, in the decision making on the incorporation of SC into that EV_S. It may include data such as:

| | |
|---|---|
| EV_A_i | An identifier of the EV |
| EV_A_fi | An identifier of each frame (or field) of video |
| | of the EV, for example, a time code (of various |
| | sorts) |
| EV_A_c | Categorization of the EV (family channel, sports |
| | channel, news channel, children's' channel, etc) |
| EV_A_gr | Group membership of the EV. Data such as: |
| | “owner”; group identifier of other networks to |
| | co-sell and/or co-place news and/or ads with |
| EV_A_pi | Identification of the content in the EV_S at a |
| | certain time (e.g.: a specific TV program, a |
| | specific movie on a DVD) |
| EV_A_pc | Categorization of the content in the EV_S at a |
| | certain time (drama, comedy, action, sports, etc) |
| EV_A_pr | Rating of the content in the EV_S at a certain |
| | time (e.g.: PG, X, etc) |

Supplementation Opportunity Attributes (SO_A):

The supplementation opportunity attributes comprise information related to the attributes of the supplementation opportunities (SO_A). That information may be used, among other ways described herein, in the decision-making process to incorporate SC into EV_S, and may include for example the following, each of which may apply to an SO, and SO_G and both and SO and an SO_G:

| | |
|---|---|
| SO_A_I | Identifier of the network in which the SO |
| | appears (SO_A_i); matchable with the EV_S_A_i. |
| | May be received explicitly or implicitly (e.g.: |
| | if the SO_A is inband in whole or in part) |
| SO_A_soi_t | Start of incorporation time |
| SO_A_soi_e | Start of incorporation event |
| SO_A_eoi_t | End of incorporation time |
| SO_A_eoi_e | End of incorporation event |
| SO_A_di | Duration of incorporation |
| SO_A_typ | The type of SO (e.g.: for replacing soundtrack, |
| | overlaying graphics, replacing TV, pertaining to |
| | replacing part (e.g. an object) of the original |
| | content being displayed, etc; essentially same as |
| | SC types) |
| SO_A_dflt | Identifier of the default content in the SO |
| SO_A_inc | Data pertaining to incorporation and said SO, |
| | including whether or not incorporation into and |
| | recording from are allowed. |
| SO_A_own | The owner of the SO (which impacts which SC may |
| | be used, and to whom the supplementation should |
| | be reported); e.g., for a TV Broadcast Network, |
| | whether the SO belongs to the National Network or |
| | to the Local TV Station. |
| SO_A_g | SO group membership |
| SO_A_g_p | Position of SO in SO Group |
| SO_A_shr | SO sharing rules (e.g. rules, if any, governing |
| | which other SC can share the SO or be in |
| | proximity) |

Following SO_A reception, the attributes are analyzed, and it is determined what part of said SO_A to retain if any (e.g.: only retain SO_A that pertains to programming customers; only retain SO_A that pertains to replacing language if RD indicates language replacement may be appropriate) and accordingly stores it in the local storage device, for possible use in the decision making process of incorporating the appropriate SC into the EV_S.

Supplementary Content (SC):

The SC is data in any applicable form, including, without limitation, video, audio, graphics, data, intended for possible incorporation into an EV_S. Examples of supplementary content and such possible incorporation are, without limitation:
Video to be overlaid, semi-transparently, on an EV_S in a certain place at a certain time in a certain manner; e.g.: a static or dynamic video banner;
Graphics to be overlaid, semi-transparently, on an EV_S in a certain place at a certain time in a certain manner; e.g.: a static or dynamic logo or bug;
A sound track to partially or fully replace the original sound track of an EV_S in a certain place at a certain time in a certain manner (e.g.: a different language (e.g.: Spanish instead of English), different music, different verbiage);
Video to partially or fully replace the original video in an EV_S in a certain place at a certain time in a certain manner (e.g.: a side-bar, bottom-bar (for letterbox), picture-in-a-picture, “product placement” in which one or more objects are replaced particularly for purposes of advertising, total replacement);
Data to partially or fully replace original data in an EV_S in a certain place at a certain time in a certain manner (e.g.: closed captioning in a different language);
Response request—in any of the above forms; i.e.: SC that encourages the viewer to respond to it (e.g. by means of a LID), such as, without limitation, a quiz (multiple-selection or other), a lottery, game show question, betting opportunity, poll, request to logon, request for subscriber data, etc.

Supplementation Content Attributes

Supplementation content attributes (SC_A) provide information about at least one item of SC, and may be used, among other ways, in decision making about incorporating SC into EV_S, and may include without limitation information about:
The type of SC and rules for its incorporation;
Owner(s) of the SC (the party(ies) to whom the rules pertain; e.g.: one or more PC and PC_G);
Whether the SC encourages subscriber's response, and response info (e.g.: correct responses);
SC Duration (for how long to display it);
SC Rules Owner(s) (the party(ies) to whom the rules pertain);
Timing Requirements, e.g.:
   First incorporation date & time (i.e.: do not incorporate the SC before this)
   Last incorporation date & time (i.e.: do not incorporate the SC after this)
   Days-of-Week and Times-of-Day to incorporate or not-to-incorporate
   Dates to incorporate or not-to-incorporate (e.g.: “blackout” dates);
Target Audience (e.g.: definitions of target subscribers and subscriber device characteristics)
Prevailing Weather Requirements;
   E.g.: “Show/don't show if temperature is in the 90's”;
Context Requirements and type, category, subject and rating of SC and context, including, e.g.:
   Categories of programs on which to incorporate and not to incorporate. E.g.: don't incorporate sexy, violent supplementary content on kids' shows, and, conversely, don't associate the supplementary content with adult-language show (by incorporating it there).
   Specific programs on which to show and not to show.
Repetition Requirements (per viewer), e.g.:
   Max. number of times to show the SC in total
   Max. number of times to show the SC per period (e.g.: day)
   Minimal elapsed time required between airings (“let at least 15 min pass before showing again”)
   Desired elapsed time between airings (try to show every half hour).
Multi-SC Campaign Requirements
   Related SCs and relationships therebetween (e.g.: related ads that together form a campaign, and are intended to be shown in some relationship to each other);

Following the extraction process, the subscriber's device deciphers pertinent attributes of SC and decides whether to retain said SC or not and accordingly stores it in a local storage device. Decision is based, for example, on matching the SC target audience (as defined in its SC_A) , the corresponding RD and storage availability on said subscriber device.

Subscriber Data (RD):

RD comprises any or all of the data associated with a subscriber and/or a subscriber device including RS_A and BC_A and/or parts thereof and may be used, among others, in the decision making about incorporation of SC.

Subscriber Attributes (RS_A):

Examples of attributes that are associated with the subscriber (RS_A) are:

Main personal attributes e.g.: age, gender, income level, ethnicity;
Additional personal attributes (many optional);
Identifying attributes e.g.: Username & PIN, social security number, email address, credit card number (especially for benefiting from the service while on the road—e.g. in hotels);
Default viewing location;
Default subscriber device
SC preferences & requests;
Reward preferences & requests;
Group Account (e.g.: family)—to enable usage credits to be amalgamated with other subscribers' in whole or in part. E.g.: viewing credits may be amalgamated for all members of a household, but individual members could participate in lotteries, quizzes and games on an individual basis;
Methods for receiving rewards with details (e.g.: account numbers) , such as check in mail, credit to bank account, credit-to-credit card, payment in kind (& which kind).

Subscriber Device Attributes (BC_A)

Examples of attributes that are associated with the subscriber (RS_A) are:

Identifying attributes e.g.: serial number, IP address
Model code, date of manufacture, etc
Manufacturer, Distributor
Date deployed
Subscriber device group membership
System parameters, including logical and/or physical switches that indicate which options to enable and disable, and values that impact their operation
Location attributes, such as:
   street address
   zip code
   information related to the address, such as income group, ethnic group, education group, voting patterns, local interests, weather (dynamic & static);
   type of building, such as single-family house, residential multi-tenant unit, hotel, hospital, business, etc;
   type of room (in such bldg) such as:
      in a residence: living room, kitchen, den, parents room, nursery, bedroom
      in hotel: luxury guest room, business guest room, standard guest room, lobby, business lounge
its predominant default audience (e.g.: male/female, age group)
Income group
Language group
Ethnic group
SC preferences & requests
Reward preferences & requests
Default subscriber profile (used, e.g., if no subscriber is explicitly logged on)

All RD reaching a BC that pertains to that BC is stored in the BC. Each BC supports (receipt, storage & usage of) multiple sets of subscriber attributes (RS_As), to accommodate the actual or potential multiple instances of subscribers registered to use it.

Programmer Data (PD):

PD comprises any or all of the members of the group consisting of PC_A, PC_G_A, PC_C and/or parts thereof.

Attributes of Programmer Customers (PC A):

Examples of attributes that are associated with the programmer customers are:
Start-date & end-date as a PC (including: for receiving service in accordance with the present invention)
TV Network identifiers and codes (including, without limitation, the network's logo(s) and/or watermark(s))
Programmer type (e.g.: broadcaster, local station, cable network, cable operator, and the like)
Incorporation algorithms used
Group memberships (multiple)—e.g.: indicators to which PC_Gs the PC belongs; listing of other PCs with whom this PC is associated; types and/or algorithms of such association.
   Programmer Customer Commands (PC C):

Examples of programmer customers include whether or not to execute incorporation, in general and per criteria including without limitation subscriber and subscriber device attributes such as age, gender, location, ethnicity, per date-and-time and per context.

Attributes of Programmer Customer Groups (PC_G_A):

Examples of attributes that are associated with the programmer customer groups are:
Start-date & end-date for validity of the said grouping;
Members of the said group (e.g.: PCs);
Pertinent group cooperation algorithms and/or rules (e.g.: “do not distinguish between members of the group when selecting and incorporating supplementary content for an SO in a PCN of a group member”).

As previously explained, the supplementation data, subscriber data and programmer data may be received by the BC in part or in whole inband. In addition or in the alternative, such data may be received in part or in whole out-of-band. It should be understood that any combination of all inband, inband+outband or all outband reception of such data is encompassed by the present invention. By a preferred embodiment of the invention, only an identifier of the network and video frame (or field) identifiers, such as time-stamp, are received inband, while all other data are received out-of-band, and are matched together as appropriate by the subscriber device based on said identifiers and on algorithms which also preferably enhance security & robustness. According to this embodiment even data which have a very strong affinity to a particular TV network, such as some data about the network (e.g. program category, rating and name, etc.) and all data about supplementation opportunities—including when they begin and end, their type, their ownership, etc.—are received out-of-band (as all other data except the abovementioned identifiers). This embodiment is inductive of minimizing additional load on the network's transport mechanisms (such as minimizing impact on compression and bandwidth needed), minimizing dependence on TV distribution operators and systems, and maximizing robustness and security of the data which is transported separately from the network.

At the other extreme, in another preferred embodiment, all data—supplementation data, programmer data and even subscriber data (which has no affinity to a specific TV network)—are transferred inband, and none are transferred out-of-band. By this embodiment, only one transport network is used, instead of several, which may afford highest simplicity with all the typical commensurate benefits, such as, in many but not all cases, ease of installation and maintenance, lower cost, etc. In other embodiments, for example, some of the EV_A and the SO_A are transported inband, while the other supplementation data, programmer data and subscriber data are transported out-of-band.

Said inband and out-of-band transport is done via one or more of the means described herein.

The data received is extracted, processed stored and used as explained herein.

In appropriate cases and circumstances, the subscriber device preferably provides a confirmation of proper reception of appropriate data.

C. Retrieving Data Pertinent to Incorporation of Supplementary Content from said the Stored Data and Determining, Based on the Retrieved Data, the Supplementation Content for Incorporation into the External Video Signal (Step 120):

Upon detecting a new value of EV_A_i (e.g.: after power up, after detection of an EV_S after a period in which none was detected, upon detection of a different EV_A_i—e.g. after a change in the channel tuned to, the device connected, the content being played on the connected device, etc.), the BC processes the data received and logs the new EV_A_i. This logging may be used for other purposes such as viewing measurement even for non-customer networks, e.g. as input for ratings.

The BC may support various forms of EV_A_i (e.g.: legacy network logo; watermarks; MPEG-7 form; in VBI; in HBI; in non-viewable lines; in the audio signal; etc.).

During operation, the BC checks and notes whether the current detected EV_A_i is of a current programmer customer (PC); i.e.: whether the current network is a programmer customer network (PCN). Various methods may be used at the BC for performing such checking, such as by looking up said EV_A_i in a table it maintains, based on PD, of PCs and their validity periods, and other methods as known in the art per se.

The BC selects SC for incorporation into the SEV_S in various circumstances.

SC Selection Triggered by SO_A:

The BC ongoingly monitors the SO_A of PCs, for example in accordance with proximity of SO_A_soi (start of insertion time or event), to identify when to incorporate SC into the PCN (or grouped EV).

At such time as is compatible with the values of the pertinent SO_A and with processing requirements and capabilities, the BC selects SC for the SO to which the said SO_A pertains, such that the SC_A of the selected SC comply with the results obtained by applying the pertinent algorithms and:
a. the values of the pertinent attributes PC_A, PC_C, EV_A and SO_A; and
b. the values of the available and pertinent of the following attributes:
   BC_A
   RS_A
   SO_G_A
   PC_G_A

and
c. the incorporation history of said SC if pertinent; and
d. if SC_G_A are available for and pertinent to the said SC—the values of the pertinent SC_G_A and the incorporation history of members of said SC_G.

In addition, the applicable algorithms may apply stochastic methods, preferably agreed upon with programmer customers, in such selection process, in particular for selecting between different items of SC that meet other selection criteria for a certain SO.

For example, selection of the SC appropriate for incorporation in an SO may be implemented by an expert system operative in the subscriber device in accordance with rules such as the following ones:

{EV_A} The owner of the EV in which the SO occurs should be a valid programmer customer (defined as a currently valid PC) and desirous of executing incorporations as expressed in PC_C and SO_A;
1. {SO_A and SC_A} The owner of the SC should be the same as the owner of the SO, directly and/or via a grouping mechanism (such as PC_G); e.g.: a local TV station's SC should not be selected for a national TV network's SO, even if the station and network are affiliated, and vice versa, unless they share said SC in accordance with a grouping mechanism;
2.{SO_A and SC_A} The type of the SC should be compatible with the type of the SO (e.g.: both 30-second slots);
3. {EV_A and SC_A} The context requirements of SC should suit the context of the EV in which the SO occurs when it occurs; e.g.: if so defined in the SC_A, the category and/or rating of the program should not be incompatible with the context requirements of the SC (e.g.: do not incorporate a beer commercial in a kids program); or: if so defined in the SC_A, the program in the EV should precisely meet said requirement (to enable implementation of a contract to place a certain commercial in a certain program);
4. {SO_A and SC_A} The timing requirements of SC should suit the timing of the said SO; e.g.: if so defined in the SC_A, the “time(s) of day to incorporate and not-to-incorporate” should not be incompatible with the timing of the SO; e.g.: do not incorporate evening supplementary content during the morning; or: if so defined in the SC_A, the timing of the EV should precisely meet said SC_A requirement (to enable implementation of a contract to place a certain commercial in a certain ad-break in a certain position);
5. {SC_A} The SC should be valid; e.g.: already available and still in effect;
6.{Activity history and SC_G_A} The SC should be selected in the desired sequence relative to related SC that together constitute an entity; e.g.: in a sequence of mutually reinforcing commercials, the second (as opposed to, e.g., the first or the third) should be selected for incorporation if the previous-incorporated item of said sequence was the first.
7. {Activity history and SC_A} If there's valid alternative SO, prefer the SC that, relative to its incorporation-frequency requirements, was last incorporated longest ago.
8. {SO_G_A} E.g.: A certain SC should not be incorporated more than once in an SO_G that is a multi-slot ad break; all SC for members of an SO_G that is a multi-type SO_G should belong to the same SC_G.
9. {RS_A, BC_A and SC_A} The target audience requirements of the SC should be compatible with the characteristics of the subscriber that is explicitly or implicitly logged on and of the subscriber device.
   SC Selection per BC Initiation:

The BC can initiate incorporation of certain SC into the SEV_S; for example, self-promotion and/or subscriber interaction SC as described herein; news alerts; public service messages; etc. If and as so prescribed by pertinent BC algorithms and enabled by BC system parameters, the BC seeks (in its storage) and if available selects, appropriate SC, such that the SC_A of the selected SC comply with the results of the said BC algorithms, EV_A, SO_A and RD_A if appropriate, and system parameters.

BC enables support of the above to be contingent on whether the current EV_S is or is not a PC network.

SC Selection per Subscriber Data:

For PCNs, if and as so stipulated by the subscriber data or BC system parameters, the BC ongoingly monitors the EV_A, for example the EV_A_pi (program identifier), to identify when to incorporate appropriate SC into the EV. This enables, for example and without limitation, incorporation in the SEV_S of:
a replacement soundtrack in a prescribed language (typically different from the EV_S's original language)—for each program for which such replacement soundtrack is available;
closed captions (replacement or additional) in a prescribed language—for each program for which such captions are available;
stock quotes, news items, weather updates if and when available—in various formats (ticker, side bar, overlay, etc.)—when available.

At such time as is compatible with the values of the pertinent EV_A and with processing requirements and capabilities, the BC selects SC for the said EV, such that the SC_A of the selected SC comply with the values of the pertinent EV_A, RD_A and system parameters.

After selecting the SC, it is retrieved from the BC storage as necessary and prepared for incorporation in the pertinent SO (whether explicit SO or implicit SO) in the pertinent EV_S.

Such preparation includes converting, at the appropriate moment, the format of the SC from the format in which it is stored to the desired output format of the EV_S (e.g.: from a digital compressed format to analog composite or component format).
e. Incorporating Supplementary Content into the External Video Signal (Step 140)

Closely adjacent to the time or the event (as applicable) prescribed for beginning of incorporation of SC selected and prepared as above for incorporation into the EV_S, in accordance with processing requirements and capabilities, the BC ascertains that the incorporation conditions are currently in effect, in accordance with the circumstances of selecting the said SC. For example, in order to prevent mis-incorporation of SC as a result of change of the EV input to the BC (e.g.: when the subscriber tunes to another channel at the STB) between selection of the SC and beginning of incorporation of said SC:
if the SC was selected per SO_A, the BC checks, among other things, whether the SO_A_i of the SO equals the current EV_A_i, and only begins incorporation if it is equal;
if the SC was selected per RD_A, the BC checks, among other things, whether the contextual requirements regarding program identifier of the SC match the current EV_A_pi, and only begins incorporation if such a match is found.

If the incorporation conditions are found to be in effect, the BC begins incorporating the SC selected and prepared as above, into the EV_S into the said SO if applicable, in the manner prescribed by the pertinent attributes, parameters and algorithms.

During such incorporation, the BC continues to ascertain, in a manner similar to that described above for start-of-incorporation, on a periodic and/or event-driven basis, whether the incorporation conditions remain in effect or not (e.g.: due to an EV_A_i change because another channel is tuned to, or EV_S from another source is input to the BC). If, during such incorporation, the incorporation conditions are no longer in effect, the BC may desist from incorporation of said SC, or may continue with such incorporation as if the said attributes were unchanged, as prescribed by the various pertinent attributes and BC's system parameters.

The BC preferably supports incorporation of all forms of SC, including without limitation, each component thereof—such as video, audio, data, graphics, voice, text—separately, and any and all combinations thereof simultaneously.

The BC preferably supports incorporation in all the domains pertinent to all supported formats of EV_S, including without limitation, analog and digital domains, component and composite domains, compressed and uncompressed domains, and any and all combinations thereof.

In addition, the BC preferably logs each incorporation of SC into EV_S, including reason for incorporation (e.g.: per SO, per subscriber data, per subscriber's request, per pre-defined algorithm), start-of-incorporation and end-of-incorporation, in accordance with PC_A, PC_G_A, SO_A, SC_A, industry practice and the BC's system parameters (e.g.: number & identification of SC video frames incorporated or dropped—if video; end-of-incorporation reason such as normal or abort with or without the reason for such an abort).

The BC preferably supports multiple, simultaneous, partially or fully overlapping incorporations, in accordance with possible multiple instances of each type of SC selection trigger. For example: overlay of a graphic logo in the video component of an EV_S simultaneously with replacement of the sound track of that EV_S.
f. Forwarding the Incorporated Signal to the Appropriate VPRD (Step 150):

The BC conveys the EV_S, whose format may have been converted as above, and into which SC may have been incorporated as above—i.e.: the SEV_S—to its output port.

In addition to the above, the method of implementing the current invention may also comprise some or all of the additional steps described hereunder.

Generating Subscriber Data:

The BC preferably analyses certain pertinent activity data in order to generate certain subscriber data. For example and without limitation:
Based on EV_A logged (e.g.: EV_A_c, EV_A_pi, EV_A_pc, EV_A_pr), viewing times and durations, etc, and using appropriate algorithms, the BC generates estimates of RS_A such as age-group, gender, special interests;
Based on subscriber inputs: (e.g.: lotteries entered and prize selections), the BC generates estimates of RS_A such as age-group, gender, and special interests.

Subscriber data so generated is stored in storage 28 in combination with and/or addition to, as appropriate, subscriber data received from other sources as described herein.

Displaying Self-promotion SC:

By yet another embodiment of the method provided by the present invention, the system includes certain integral measures to promote its usage to viewers, for purposes including, without limitation:
1. encourage and enable viewer to register personally for service as a subscriber;
2. encourage and enable a subscriber to log on;
3. encourage and enable a subscriber to update subscriber data
4. encourage and enable a subscriber to update supplementation content requests and preferences;
5. encourage and enable an subscriber to update reward requests and preferences;
6. encourage and enable an subscriber to interact with supplementation content for greater rewards;
7. encourage and enable a subscriber to participate in promotions;
8. alert viewer to options and conditions (e.g.: impending log-off for excessive duration of non-activity; exceeding abuse-prevention thresholds, etc);
9. remind viewer that he/she is being served by the service provider and receiving its benefits
10. guide the viewer how to get the most out of the service (e.g.: tune to our customers' networks in general and during ad breaks in particular; use On Demand Advertising).

For such a purpose, the NS transfers to the subscriber's device, SC appropriate for such promotional purposes, and marked as such in its SC_A.

The BC initiates incorporation of such promotional SC in circumstances such as:
Upon power-up of the BC;
Upon detecting an EV_S after a prescribed period of non-detection;
Upon detecting a change in EV_A_i, or certain sequences of changes in EV_A_i (e.g.: a sequence that indicates the viewer is channel-surfing, such as at least x changes in the last y seconds);
Upon detecting a log-on by a subscriber.
   Detection (e.g.: of Viewing)

By yet another embodiment of the method provided by the present invention, the subscriber device, using its appropriate means, periodically and/or upon prescribed events, checks whether a viewer is present, whether a VPRD is connected and active, and/or whether an EV_S source is connected and active, and logs the results of such checks.

Carrying Out Logging Activities:

By still another embodiment of the method provided by the present invention, the subscriber device logs data about supplementation activities, subscriber activities and viewing detecting activities performed by or via the subscriber device, in an appropriate manner, in subscriber device storage.

Such logging preferably includes data about the specific activity (such as, without limitation, a code indicating incorporation of a specific type of supplementary content into a specific type of supplementation opportunity; a code indicating a certain type of subscriber activity; identifier of the content incorporated if appropriate; the data input by subscriber or derivative thereof if appropriate}, and “common data” (such as, without limitation, date & time of said activity).

Handling Activity Data

By yet another embodiment of the method provided by the present invention, pertinent activity data and pertinent subscriber data (i.e.: subscriber data that were generated locally by the subscriber device or input by a subscriber to the subscriber device) are retrieved from time to time from its storage. A signal (or signals) for carrying said data is then constructed, and transmitted to processing center(s), by one or more of the means described above. Preferably, elements of such data that are no longer used in ongoing processing are erased from local storage after successful transmission in accordance with prescribed data retention and maintenance requirements and procedures.

In accordance with yet another aspect of the present invention, the configuration of the subscriber device (BC) can be optimized for and adapted to the environment and circumstances for which it is used. For example, different embodiments may be applied for a one-TV studio apartment, a multi-TV home, a Multi-Tenant Unit (e.g.: apartment building) and a hotel. There are cases where the subscriber device is a stand-alone device while other cases where the BC is hosted, in whole or in part, in another device. Some examples of configurations in which the subscriber device(s) may be used are:
1. Individual subscriber device—supports one VPRD (such as a TV Set). It may be:

Independent—a stand-alone device;

Embedded—a subscriber device that is at least partially embedded, e.g. as a module, board, chip, software, etc., in the VPRD (such as a TV set, PVR), and utilizes one or more of that device's resources (e.g.: the “host's” outer packaging, the power supply, various processor(s), storage means, network interfaces, etc.).
2.Multi-user subscriber device—can support several VPRDs (such as a TV Sets). It may comprise, for example, in a client-server architecture: a central device—which supports multiple supplementation terminals, and may be:
   stand-alone (in various forms);
   embedded (at least partially as a module, board, chip, software, etc.)—e.g. in a Home Media Server or Residential Gateway.
   multiple supplementation terminals, each of which supports one VPRD and may be:
      stand-alone (in various forms);
      embedded (at least partially as a module, board, chip, software, etc)—e.g.: in a TV Set, PVR;
   means for communications between the central device and supplementation terminal(s), e.g. as described herein for communications within a building.

In these “multi-user” cases, the above-described means and methods of the subscriber device are embodied in part in the “central device” and in part in the “supplementation terminal” units, and in part in both, depending on various design considerations. Furthermore, the implementation of said means and methods in the “central device” and in the “supplementation terminal” units may differ depending on various design considerations. For example, in a preferred embodiment of the invention, both non-volatile and volatile storage and staging means are used in the “central device”, while only volatile storage and staging means are used in the “supplementation terminal” units.

In cases where the subscriber device is embedded, in whole or in part, in a host device as described above, the various subscriber device means for receiving and transmitting (such as 30, 32 and 50, and to 24 and from 26, which were described in FIG. 2) may be adapted, as appropriate, to receive from and/or transmit to the host device, by appropriate means, such as software means (for example application program interfaces) and hardware means (for example interfaces to and within integrated circuits, buses, etc).

In cases where the subscriber device is embedded, in whole or in part, in a host device as described above, the current invention comprises further means, implemented in the subscriber device in whole or in part and their corresponding counterparts in processing center(s) in whole or in part, to, periodically or otherwise, calculate and assign rewards to a party or parties associated with the host device, such that said rewards may or may not be a function of the scope and nature of various activities of, on and/or associated with said embedded subscriber device.

In cases where the subscriber device is not embedded (at least partially) in a host device as described above, the non-embedded part of the subscriber device may comprise further means, to allow clipping on to a device such as a TV set or PVR, and to interface with said device via its connectors and/or programming interfaces, and preferably, to use one or more of said devices resources, such as power supply, processors, storage, and the like, instead of and/or in addition to corresponding means of the subscriber device described herein.

Human Interaction

For purposes of user-BC interaction, the BC supports receiving input from users by means of a LID in one or more various modes, including, without limitation, such as:
“Menu-driven”: in response to multiple choices, presented visually, (for example on the VPRD, by means of SC incorporated into the SEV_S and/or such choices displayed in the original EV) and/or audibly (for example over a sound system by the subscriber device), where each such choice is identified—for example, by a number—the user inputs, by means of a LID, an identifier corresponding to a choice so presented or navigates the cursor using navigation keys to the desired choice and uses an appropriate LID key to select said choice;
“Command-driven”: the user presses certain LID keys which have been pre-selected for specific purposes and/or values.

In such interactions, the BC may provide audio and/or visual output to the user (e.g. via a VPRD, by incorporating BC-generated SC of various types into the SEV_S and/or by means of a sound system).

The subscriber device may support various types of user interaction as needed and appropriate to achieve its purposes, including, without limitation, one or more of the following:
1. promotions to viewers
2. Viewer registration
3. Viewer subscriber data input
4. Viewer log-on
5. Viewer confirmation of presence
6. Viewer request for incorporation of SC.
7. Viewer response to SC and EV that encourage RS responses; e.g.: quizzes, lotteries, promotions
8. Viewer use of value added services
   Betting
   Buying (e.g.: from ads and shopping channels)
   Shopping
   Voting
   Gaming
   Request for additional information, coupon, voucher etc—related to a product, event, person etc presented in the SEV_S—to be delivered offline or online, via the subscriber device or other means (such as email to subscriber)

The subscriber device preferably logs user interactions (e.g.: for subsequent click-stream analysis). Some of these user interactions are described further below.

Viewer Confirmation of Presence:

In accordance with an embodiment of the present invention, the subscriber device may preferably recognize a range of user activities as confirmations of viewer presence. For example: any of the following may be deemed a confirmation of presence, possibly in accordance with settings of subscriber device parameters:
any signal detected via the subscriber device means which are operative to receive signals from the local input device, be it intended for and decipherable by the subscriber device or nor;
detection of a change in EV_A_i;
detection of a viewer response to a solicitation of such a response by the subscriber device;
detection of a viewer command specifically defined to confirm presence;

In cases such as the latter two, this embodiment of the current invention may further incorporate a step of assigning a reward or credit towards a reward to said viewer for actively confirming presence.

Viewer Request for Incorporation of SC:

By this embodiment the BC enables users to request incorporation of certain SC. This enables, for example and without limitation, incorporation, in response to the subscriber's request, of:
A replacement soundtrack in a prescribed language (typically different from the EV_S's original language)—on command, if available;
Closed captions (replacement or additional) in a prescribed language (typically different from the EV_S's original language)—on command, if available;
Stock quotes, news items, weather updates—in various formats (ticker, side bar, etc.)—on command, if available.
Output of SC (of stipulated types; e.g.: certain ads, certain news) instead of the content of the EV_S, for a stipulated period, irrespective of SOs and EV_A;
Overlaying of SC (of stipulated types; e.g.: certain ads, certain news) on the EV_S, for a stipulated period, irrespective of SOs and EV_A;
Creation, by the BC, of virtual SOs (of various types) in the EV_S (e.g.: by time-shifting of the EV_S, pause of the EV_S from a source such as VoD or local playout device), and incorporation of appropriate SC therein (e.g.: in “commercial-free” networks, VoD, EV_S from a consumer electronic device, etc).

If and as so requested by RS and enabled by BC system parameters, the BC seeks (in its storage) and if available selects, appropriate SC, such that the SC_A of the selected SC comply with the values of the pertinent RS commands, EV_A if appropriate, RD_A and system parameters.

BC enables incorporation of all or some such SC to be contingent on whether the current EV_S is or is not a PCN.

The system of the present invention may further include mechanisms for preventing abuse of this option (e.g.: avoid paying viewer, and taking credit from advertiser, for excessive airing of an ad), as described herein.

Viewer Response to SC and EV that Encourage Response:

According to still further embodiment of the present invention, some SC encourage the subscriber to respond (using a LID).

For example, SC that presents trivia quiz questions and encourages the user to answer; SC that enables the user to guess an outcome—e.g.: place a bet.

Response is typically by selecting one of several options presented by the SC, or inputting a value, etc.

Upon incorporating such SC, the BC prepares to receive a response via a LID, in accordance with stipulations of the SC_A (e.g.: for a certain period of time following incorporation of the said SC).

Upon receipt of such user response, the BC logs it, recording the value received or a derivative thereof (e.g.: correct/incorrect) and may further process it (e.g. storing locally or transmitting a presentation of the processed response to a processing center, etc.)

According to another aspect of the invention there are provided one or more processing center to which a plurality of subscriber devices are communicationally connected. Such a processing center comprises for example some or all of the following:
means for registering subscriber devices and subscribers and updating data pertaining to them;
means for monitoring subscriber devices' and subscribers' activities;
means for generating and/or modifying contracts with customers regarding supplementary content and its incorporation in accordance with this invention;
means for receiving, storing and retrieving and processing supplementation data, subscriber data and/or programmer data and for creating and storing various appropriate derivatives thereof;
means for receiving, storing and retrieving and processing activity data and for creating and storing various appropriate derivatives thereof;
means for communicating with subscriber devices, programmer customers and their facilities, agents, suppliers etc, and other parties such as market researchers etc.;
means for calculating bills, credits and rewards for customers;
means for calculating rewards, credits and bills for subscriber devices, subscribers, subscriber device hosts and other related parties, and for generating and supporting agreements with them;
means for generating reports and/or statements (bills, debit & credit statements, reward statements, subscriber device and subscriber activity, viewing measurements, etc.) for programming customers, other parties (e.g.: for demographics researchers and market researchers) and subscribers;
means for managing and monitoring the distribution of such reports, bills and statements and the implementation of their ramifications accordingly (e.g.: collection of amounts due and distribution of rewards due);
means for administering, managing, controlling, securing and maintaining the operation of processing centers and subscriber devices;
means for ensuring the integrity, security and authenticity of all the signals received and transmitted;
means for ensuring the integrity and/or security of the data stored; and/or
means for erasing from storage elements of data that are no longer used in ongoing processing in accordance with prescribed data retention and maintenance requirements and procedures.

Some examples of these means are described further hereunder.

Means for Registering Subscribers and Updating Their Data

According to a preferred embodiment of the present invention, there is provided processing centres that support means to enable authorized parties (such as distributors, installers, service providers, database managers, data-mining services, etc), and preferably the subscriber, to provide and update RD to processing centers, such as, without limitation:
Customer service desk for providing data by telephone;
Customer service website for providing data via the Internet;
Computer-to-computer data links—e.g.: EDI, file transfer—e.g.: from computer systems of distributors, market researchers, demographics analysts and data-mining services, etc.
The subscriber data so added to a NS is transferred from the NS to applicable BCs as appropriate.
   Means for Generating and/or Modifying Contracts With Customers

Said means enable and support an implementor of the current invention and a user thereof (such as a programmer customer) to generate and agree on contractual agreements between them that specify, among other aspects, the charging and billing schemes and methods to be applied, the methods by which supplementary content, reports etc. are to be transferred between them, the conditions under which each item of said user's supplementary content should be incorporated into EV_Ss, the EV_Ss into which such incorporation should take place, the times at which such incorporation should take place, the number of times such incorporation should take place, the reporting required about such incorporation, etc. Without limiting their scope, said contractual agreements preferably support said specification by any value of any of the data items provided herein as examples of supplementation data, subscriber data, customer data and activity data, and the current invention preferably comprises the means and methods to faithfully and accurately implement such contractual agreements.

For example, the current invention preferably enables specification that a certain item of SC be incorporated if and only if the EV_A_i is of one specific value, and the EV_A_pi is of one specific value and the SO_A_soi is of one specific value, and the subscriber data matches certain attributes of the SC. As another example, the current invention preferably also enables specification that a certain item of SC may be incorporated if the EV_A_i value is included a specific set and/or the EV_A gr is included in specific set, and the EV_A_pi meets specific terms of inclusion and exclusion, and the EV_A_pc and EV_A_pr meet specific terms of inclusion and exclusion, and the SO_A_soi complies with the SC's timing requirements, and the subscriber data matches certain attributes of the SC.

Such charging schemes and methods may be referred to as “Default content in a supplementation opportunity with Substitution”:

In accordance with an embodiment of the present invention, following is an example of such a scheme which makes a distinction between “default SC” and “substitute SC”:
Default SC is incorporated into the external video signal by the programmer customer in the legacy manner (i.e.: at source).
Substitute SC is incorporated into the external video signal by the system of the current invention for the programmer customer (i.e.: adjacent to viewing points);

The programmer customer requires a “target profile” to be defined for each SC, and offers the following service to advertisers and other parties that wish to have SC incorporated (as outlined below per SO):
Default SC will be aired at all VPRDs not using the device of the current invention, and at all VPRDs using the device of the current invention whose profile matches its target profile;
Substitute SC will be aired instead of default SC at VPRDs using the device of the current invention whose profile does not match the default SC's profile and does match its profile;
Overlap of target audiences is handled by appropriate rules.
   The pricing scheme is:
The price for incorporating default SC is the legacy price (i.e.: of selling the whole SO for one SC) reduced as an increasing function of the number of viewers for whom substitute SC was incorporated. That price reduction can be made for example (i) in advance, e.g. based on the number of VPRDs connected via a device according to the current invention and their profiles, or (ii) after airing, e.g. based on actual measurement of airing and substitution, or (iii) a combination of the two).
THe price for a substitute SC is an increasing function of the number of viewers for whom it is incorporated (calculated in advance or after airing or a combination thereof, as above).
Preferably, even the price-per-viewer is a non-decreasing function of the number of viewers for whom it is incorporated; e.g.: SC that takes 5% of the audience pays more per viewer (but less in total) than SC that takes 20% of the audience.
   For this scheme, let:
a—size of the audience (number of viewers) of an SO
q—default SC's share of the audience (i.e.: the portion of “a” that is the default SC's target)
sᵢ—substitute SC i's share of the audience (assuming, for simplicity, that's its the same in the whole audience)
p—price per viewer the legacy way
mᵢ—price-per-viewer multiplier for audience share sᵢ; i.e.: if price-per-viewer the legacy way (one SO one SC) is p, then price-per-viewer per the current invention for a sᵢ portion of the audience is mᵢp. We expect mᵢ will be a decreasing function of sᵢ (the higher the share of the SO, the lower the price per viewer). Note: mᵢ>1.
d—discount-per-substituted-viewer (to default SC) factor; i.e.: discount of dp to default SC per substituted viewer. Note that d<1.
t—portion of the audience that uses the current invention (assuming for simplicity that t is uniform across all segments of the audience)
Rₛ—Programmer customer's revenue from substitute SCs in a single SO using the current invention
R_{d}—Programmer customer's revenue from default SC in a single SO using the current invention
R_{T}=Rₛ+R_{d}
R₀—Programmer customer's revenue not using the current invention (R₀=ap)
   Then:
2) Rs=Σ(atsᵢ)(mᵢp)=tapΣsᵢmᵢ
2) R_{d}=ap−dp Σatsᵢ=ap(1−tdΣsᵢ)
3) R_{T}/R₀=tΣsᵢmᵢ+1−tdΣsᵢ=1+t(Σsᵢmᵢ−dΣsᵢ) (>1, since mᵢ>1 and d<
   Or assuming, for simplicity, mᵢ=m for all i:
   R_{T}/R₀=1+t(m−1)Σsᵢ
   Means for Calculating Bills, Credits and Rewards for Programmer Customers

According to still another embodiment of the invention, there is provided means that preferably support a variety of schemes and methods of charging and billing for incorporation of SC in accordance with the current invention, including, for example and without limitation, any of the following and/or combinations thereof:
flat charge;
flat charge determined by the number of registered subscriber devices and/or subscribers whose attributes meet specified criteria (e.g.: the number of registered subscriber devices located in households whose income is estimated, based on address and related demographic data, to be in a certain range);
charge as a function of number of incorporations performed;
charge as a function of number of incorporations performed where an incorporation is deemed performed only if it meets certain specified criteria (such as: incorporation of a 30-second video sequence is deemed performed only if no more than 1 frame was dropped from the beginning of the sequence and no more than 1 frame was dropped from the end of the sequence);
charge as function(s) of number of incorporations performed for each of certain sets of values of subscriber data attributes (of subscriber devices for which such incorporation was performed);
disclosure in relation to charges, by the implementor of the current invention to a user thereof, of only aggregate incorporation-performance data;
disclosure in relation to charges, by the implementor of the current invention to a user thereof, of one or more category subtotals of incorporation-performance data (e.g.: categorized by various items of subscriber data);
disclosure in relation to charges, by the implementor of the current invention to a user thereof, of subscriber-level details of incorporation-performance data;
   Means for Calculating Rewards, Credits and Bills for Subscriber Devices, Subscribers, Subscriber Device Hosts and Other Related Parties

By yet another embodiment of the present invention, this means preferably support some or all of the following:
calculating and assigning rewards at multiple levels; e.g.: at the subscriber level and one more subscriber-group levels; at the individual's level and at the household level;
calculating and assigning rewards by various algorithms and/or methods, e.g.: irrespective of activity (e.g.: just for subscribing and activating subscriber device) and/or as various functions of activity (e.g.: as a function of quantity of SC incorporated, possibly while “VPRD on” and “subscriber present”); in a deterministic manner and/or in a stochastic manner (e.g.: involving some form of lottery);
calculating and assigning various forms of rewards; e.g.: monetary payment, goods (selected in whole or in part by the implementor of the current invention, users thereof such as programmer customers, subscribers thereof, etc.), discount coupons, vouchers, credit to accounts, tickets (e.g.: to concerts and/or events), lottery tickets and/or participation.
combating abuse of reward-earning, by, e.g., limiting the total reward-credit achievable in one or more periods; limiting the total reward-credit achievable, possibly in a period, from a specific item or group of items of SC; limiting the total reward-credit achievable, possibly in a period, from a certain PC;
calculating and assigning such rewards for subscribers, subscriber groups and/or parties associated with devices that host, in whole or in part, as described herein, “embedded” subscriber devices and/or other parties involved in implementing certain instances of the current invention;
means for generating and supporting contractual agreements with subscribers and other parties described herein, regarding rewarding in connection with implementation and operation of the current invention.

It will be appreciated that the above-described methods may be varied in many ways, including but not limited to, changing the exact implementation used. It should also be appreciated that the above described description of methods and networks are to be interpreted as including network in which the methods are carried out and methods of using the network components.

The present invention has been described using non-limiting detailed descriptions of preferred embodiments thereof that are provided by way of example and are not intended to limit the scope of the invention. It should be understood that features described with respect to one embodiment may be used with other embodiments and that not all embodiments of the invention have all the features shown in a particular figure. Variations of embodiments described will occur to persons of the art. Furthermore, the terms “comprise”, “include”, “have” and their conjugates shall mean, when used in the claims “including but not necessarily limited to”.

1. Apparatus adapted to enable presentation at a subscriber premise of supplemented video signal in place of externally provided video signal, and comprising:
means for receiving at least one externally provided video signal;
means for receiving information related to attributes associated with said at least one externally provided video signal;
means for receiving information related to attributes associated with at least one supplementation opportunity related to said at least one externally provided video signal;
means for receiving at least one supplementary content signal and deriving therefrom information related to at least one supplementary content unit carried therein;
means for receiving information related to attributes associated with said at least one supplementary content unit;
storage means for storing at least part of the information related to at least one supplementary content unit and for storing at least part of the information related to the attributes associated with said at least one supplementary content unit;
means for extracting information related to at least one supplementary content unit out of said storage means, in accordance with information derived from at least two members of the group consisting of:
a) said information related to attributes associated with at least one supplementation opportunity;
b) said information related to attributes associated with said at least one supplementary content unit; and
c) said information related to attributes associated with said at least one externally provided video signal;
means for incorporating said extracted information into said externally provided video signal to form a supplemented video signal; and
means for conveying said supplemented video signal.

2. An apparatus according to claim 1, wherein at least part of the attributes associated with said at least one supplementary content signal comprise information that enables identifying at least one member of the group associated with said at least one supplementary content signal and consisting of: party, type, duration, context requirements, audience requirements, timing requirements, repetition requirements and relationship requirements.

3. An apparatus according to claim 1, wherein at least part of the attributes associated with said at least one supplementation opportunity comprise information that enables identifying at least one member of the group associated with said at least one supplementation opportunity and consisting of: party, identifier, type, start, end, default content identifier and relationship requirements.

4. An apparatus according to claim 1, wherein at least part of the attributes associated with said at least one external video signal comprise information that enables identifying at least one member of the group associated with said at least one external video signal and consisting of: party, identifier, category, content, content-category, content-rating and group relationships.

5. An apparatus according to claim 2, wherein said party is selected from among a TV broadcast network programmer, a local TV station, a cable TV network programmer, a satellite TV network programmer, an Internet TV programmer, a Video On Demand programmer and a TV program syndicator.

6. An apparatus according to claim 1, further comprising means for receiving information related to one or more viewer intended to view a display of said supplemented video signal.

7. An apparatus according to claim 1, wherein said means for extracting information related to at least one supplementary content unit is adapted to extract at least one supplementary content unit that matches pre-defined values of pre-determined attributes associated with one or more viewers.

8. An apparatus according to claim 1, further comprising means to enable reporting the incorporation of supplementary content to an external location.

9. An apparatus according to claim 1, further comprising means for creating supplementation opportunities for incorporating supplementary content units in an externally provided video signal.

10. A system adapted to enable presentation, at a subscriber premise, of supplemented video signals in place of externally provided video signals, and comprising:
a central device which comprises:
means for receiving supplementary content signals and deriving therefrom information related to supplementary content units carried therein;
means for receiving information related to attributes associated with said supplementary content units;
storage means for storing at least part of the information related to said supplementary content units and for storing at least part of the information related to the attributes associated with said supplementary content units;
means for selecting supplementary content units for incorporation into at least one video signal to be displayed at at least one device connected to or hosting a supplementation terminal associated with said central device, extracting information related to said supplementary content units out of said storage means, and deciding on their incorporation within the externally provided video signals;
means for forwarding said supplementary content units thus selected towards at least one supplementation terminal;
at least one supplementation terminal which comprises:
means for receiving from said central device supplementary content selected for incorporation into an external video signal at said at least one supplementation terminal;
means for incorporating supplementary content thus received into said external video signal;
means for forwarding externally provided video signals in which supplementary content unit has been incorporated to enable the display of the supplemented externally provided video signals.

11. A system adapted to enable presentation, at a plurality of subscriber premises each provided with an apparatus according to claim 1, of supplemented video signal in place of externally provided video signals, wherein said system comprising:
at least one processing center;
means operative to convey supplementation data to said processing center;
means operative to convey programmer data to said processing center;
means operative to convey subscriber data to said processing center;
means operative to process the data conveyed to said processing center; and
means operative to convey processed information from said processing center to said plurality of subscribers' apparatus.

12. A system according to claim 11, wherein said processing center is operative to store and process one or more of the group consisting of: supplementation data, programmer data, subscriber data and any combination thereof and to create appropriate derivatives thereof.

13. A system according to claim 11, further comprising a plurality of transport means adapted to receive subscribers' data and activity data from said plurality of subscriber devices and convey signals corresponding to the data received to said process center.

14. A system according to claim 11, wherein each of said means operative to convey data to said processing center and from said processing center to said plurality of subscriber devices, is a member selected from the group that consists of: means for using radio datacasting; means for using TV datacasting; means for using satellite datacasting; means for using cable distribution infrastructure; means for using satellite distribution infrastructure; means for using cellular broadcasting; means for using cellular multicasting; means for using cellular unicasting; means for using Internet broadcasting; means for using Internet multicasting; means for using Internet unicasting; means for using wired infrastructure; means for using wireless infrastructure; means for using data network broadcasting; means for using data network multicasting; and means for using data network unicasting.

15. A method for enabling presentation at a subscriber premise of supplemented video signal in place of externally provided video signal, which comprises:
at least one externally provided video signal;
receiving information related to attributes associated with said at least one externally provided video signal;
receiving information related to attributes associated with at least one supplementation opportunity related to said at least one externally provided video signal;
receiving at least one supplementary content signal and deriving therefrom information related to at least one supplementary content unit carried therein;
receiving information related to attributes associated with said at least one supplementary content unit;
storing at least part of the information related to at least one supplementary content unit;
storing at least part of the information related to the attributes associated with said at least one supplementary content unit;
extracting information related to at least one supplementary content unit, in accordance with information derived from at least two members of the group consisting of:
a) said information related to attributes associated with at least one supplementation opportunity;
b) said information related to attributes associated with said at least one supplementary content unit; and
c) said information related to attributes associated with said at least one externally provided video signal; and
incorporating said extracted information into said externally provided video signal to form a supplemented video signal.

16. A method according to claim 15, which comprises associating attributes with one or more supplementary content signals comprising information that enables identifying at least one member of the group associated with said at least one supplementary content signal and consisting of: party, type, duration, context requirements, audience requirements, timing requirements, repetition requirements and relationship requirements.

17. A method according to claim 15, which comprises associating attributes with one or more supplementation opportunities comprising information that enables identifying at least one member of the group associated with said at least one supplementation opportunity and consisting of: party, identifier, type, start, end, default content identifier and relationship requirements.

18. A method according to claim 15, which comprises associating attributes with one or more external video signals comprising information that enables identifying at least one member of the group associated with said at least one external video signal and consisting of: party, identifier, category, content, content-category, content-rating and group relationships.

19. A method according to claim 15, wherein a party providing said attributes associated with said at least one supplementary content unit is selected from among a TV broadcast network programmer, a local TV station, a cable TV network programmer, a satellite TV network programmer, an Internet TV programmer, a Video On Demand programmer and a TV program syndicator.

20. A method according to claim 15, wherein a supplementation content unit shall be incorporated within an externally provided video signal, in case that each of the following criterion apply:
(i) if the value of EV_A_i is within a pre-defined set of EV_A_i's and/or the EV_A_gr value is within a pre-defined set of EV_A_gr's;
(ii) if EV_A_pi meets pre-defined terms of inclusion and exclusion;
(iii) if EV_A_pc meets pre-defined terms of inclusion and exclusion;
(iv) if EV_A_pr meets pre-defined terms of inclusion and exclusion; and
(v) if SO_A_soi complies with the pre-defined SC's timing requirements.

21. A method according to claim 20, further comprising the condition that:
(vi) if the relevant subscriber data matches certain attributes of the SC.
